(19) United States
(12) Patent Application Publication
(10) Pub. No.: US 2011/0003118 A1
(43) Pub. Date: Jan. 6, 2011

(54) MEMBER FOR IMAGE FORMING APPARATUS, IMAGE FORMING APPARATUS, AND UNIT FOR IMAGE FORMING APPARATUS

(75) Inventors: Shigemi OHTSU, Kanagawa (JP); Shogo Hayashi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/780,604

(22) Filed: May 14, 2010

(30) Foreign Application Priority Data
Jul. 2, 2009 (JP) 2009-157846
Jul. 2, 2009 (JP) 2009 157847
Nov. 4, 2009 (JP) 2009-253108

(51) Int. Cl. G11B 5/64; G03G 15/01; G03G 15/20; C08L 77/00

(52) U.S. Cl. 428/141; 524/606; 428/473.5; 428/220; 399/302; 399/333

(57) ABSTRACT

A member for an image forming apparatus is provided, the member including a surface layer, at least an outer surface of the surface layer containing a fluorinated polyimide resin that has an ether group in a main chain of the fluorinated polyimide resin.

### CROSS-REFERENCE TO RELATED APPLICATIONS

This application is based on and claims priority under 35 U.S.C. 119 from Japanese Patent Applications No. 2009-157846 filed Jul. 2, 2009, No. 2009-157847 filed Jul. 2, 2009, and No. 2009-253108 filed Nov. 4, 2009.

### BACKGROUND

1. Technical Field

The present invention relates to a member for an image forming apparatus, an image forming apparatus, and a unit for an image forming apparatus.

2. Related Art

In an image forming apparatus such as copier, printer, facsimile and electrophotographic device, members for an image forming apparatus, such as fixing or intermediate transfer belt and fixing or intermediate transfer roll formed from a rotating body made of metal, plastic, rubber or the like, to fix or transfer an unfixed or untransferred image (e.g., toner image) on a recording member (e.g., recording paper) by heating, electrostatic force or the like, are used.

The fixing or intermediate transfer roll has a configuration, for example, where an elastic layer having elasticity, a surface layer having releasability, and the like are stacked and formed on a support composed of aluminum, iron, stainless steel or the like. Here, a silicon rubber or the like is used for the elastic layer, and a fluororubber, a fluororesin or the like, particularly a fluororesin in view of releasability, is often used for the surface layer.

With recent reduction in size and enhancement of performance of an image forming apparatus, it is sometimes preferred for the above-described rotating body to be deformable, and a seamless endless belt formed from a thick plastic-made film is used as such a rotating body. As to the material used for such an endless belt, a polyimide resin is suitably used in view of strength, dimensional stability, heat resistance and the like (hereinafter, the polyimide is sometimes simply referred to as “PI”).

As the surface layer (release layer) of the fixing roll, a ETA resin (tetrafluoroethylene-perfluoroalkyl vinyl ether copolymer) is mainly used, and depending on the case, a resin in which carbon is dispersed to enhance the electroconductive property, a resin in which an inorganic filler such as SiO₂ and BaSO₄ is mixed to enhance the durability, or the like is used.

A surface layer (release layer) composed of fluororesin does not directly adhere to an elastic layer composed of silicone and therefore, a method of, after surface treatment with excimer laser, providing an adhesive layer such as silane coupling agent is employed.

As the release layer of the endless belt, a PFA resin (tetrafluoroethylene-perfluoroalkyl vinyl ether copolymer) is mainly used, and depending on the application, a resin in which carbon is dispersed to enhance the electroconductive property, a resin in which an inorganic filler such as SiO₂ and BaSO₄ is mixed to enhance the durability, or the like is used.

In the case of using an endless belt in an electrophotographic device, depending on the application where the endless belt is used, it is sometimes required to decrease the sliding resistance of a sliding sheet (support) disposed to come into contact with the inner circumferential surface of the endless belt or suppress a sliding noise that is generated when the endless belt is rotated. Also, in some cases, an endless belt differing in the surface roughness between the outer circumferential surface and the inner circumferential surface such that the outer circumferential surface is a smooth surface in view of image quality and the inner circumferential surface is a rough surface in view of belt running property, is required.

### SUMMARY

According to an aspect of the present invention, there is provided a member for an image forming apparatus, including: a surface layer, at least an outer surface of the surface layer containing a fluorinated polyimide resin that has an ether group in a main chain of the fluorinated polyimide resin.

### BRIEF DESCRIPTION OF THE DRAWINGS

Exemplary embodiments of the present invention will be described in detail based on the following figures, wherein:

FIG. 1A is a perspective view showing a roll (when a single layer of a surface layer is supported on a support) for an image forming apparatus according to a first exemplary embodiment of the roll for an image forming apparatus, which is a first preferable aspect of the present invention;

FIG. 1B is a longitudinal sectional view of the roll for an image forming apparatus shown in FIG. 1A;

FIG. 1C is a transverse sectional view of the roll for an image forming apparatus shown in FIG. 1A;

FIG. 2A is a perspective view showing a roll (when a multilayer consisting of a surface layer and an elastic layer is supported on a support) for an image forming apparatus according to a second exemplary embodiment of the roll for an image forming apparatus, which is a first preferable aspect of the present invention;

FIG. 2B is a longitudinal sectional view of the roll for an image forming apparatus shown in FIG. 2A;

FIG. 20 is a transverse sectional view of the roll for an image forming apparatus shown in FIG. 2A;

FIG. 3A is a perspective view showing an endless belt (when formed from a single layer of a surface layer) for an image forming apparatus according to a first exemplary embodiment of the endless belt for an image forming apparatus, which is a second preferable aspect of the present invention;

FIG. 3B is a longitudinal sectional view of the endless belt for an image forming apparatus shown in FIG. 3A;

FIG. 3C is a transverse sectional view of the endless belt for an image forming apparatus shown in FIG. 3A;

FIG. 4A is a perspective view showing an endless belt (when formed from a multilayer consisting of a surface layer and base material layer) for an image forming apparatus according to a second exemplary embodiment of the endless belt for an image forming apparatus, which is a second preferable aspect of the present invention;

FIG. 4B is a longitudinal sectional view of the endless belt for an image forming apparatus shown in FIG. 4A;

FIG. 4C is a transverse sectional view of the endless belt for an image forming apparatus shown in FIG. 4A;

FIG. 5A is a perspective view showing an endless belt (when formed from a multilayer consisting of a surface layer, a base material layer and an elastic layer) for an image forming apparatus according to a third exemplary embodiment of the endless belt for an image forming apparatus, which is a second preferable aspect of the present invention;

FIG. 5B is a longitudinal sectional view of the endless belt for an image forming apparatus shown in FIG. 5A;

FIG. 5C is a transverse sectional view of the endless belt for an image forming apparatus shown in FIG. 5A; and

FIG. 6 is a perspective view showing a state where the endless belt for an image forming apparatus shown in FIG. 3A is supported by a support.

### DETAILED DESCRIPTION

### First Preferable Aspect

### [Roll for Image Forming Apparatus According to First Exemplary Embodiment]

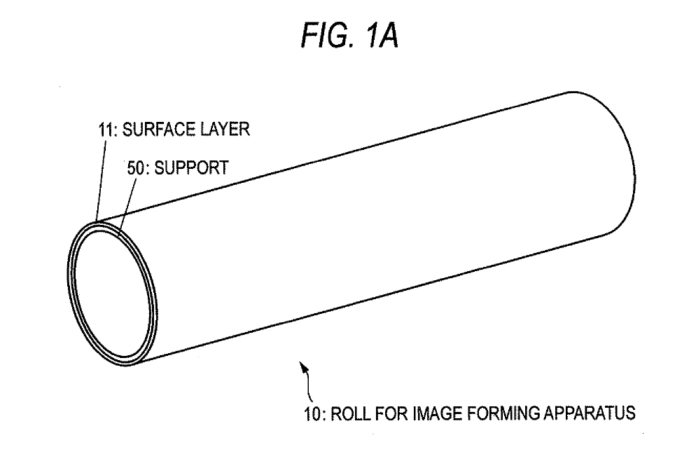

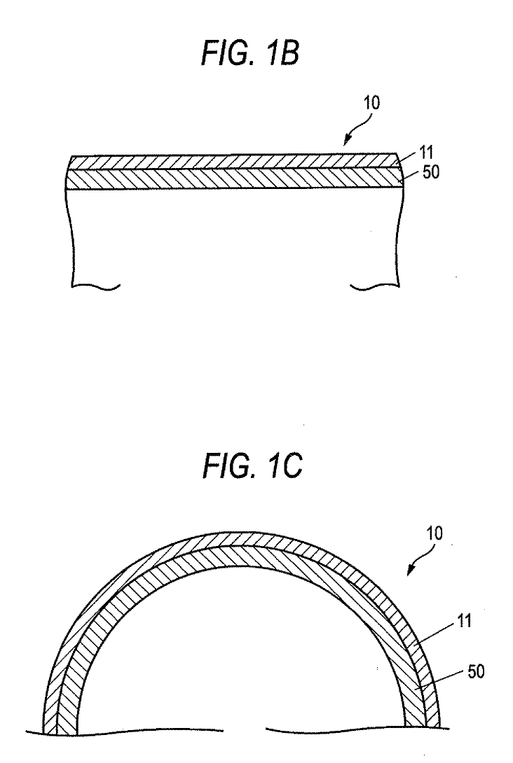

FIG. 1A is a perspective view showing a roll (when a single layer of a surface layer is supported on a support served as a base layer) for an image forming apparatus according to a first exemplary embodiment of the roll for an image forming apparatus, which is a first preferable aspect of the present invention. FIG. 1B is a longitudinal sectional view of the roll for an image forming apparatus shown in FIG. 1A. Also, FIG. 1C is a transverse sectional view of the roll for an image forming apparatus shown in FIG. 1A.

As shown in FIGS. 1A to 1C, the roll 10 for an image forming apparatus according to a first exemplary embodiment of the roll for an image forming apparatus of the present invention is a roll 10 for an image forming apparatus, used as a fixing or intermediate transfer roll that fixes or transfers an unfixed or untransferred image on a recording member in an image forming apparatus (not shown) of forming an image on a recording member (not shown), and the roll has a cylindrical surface layer 11 coming into contact with a recording member at the fixing or transfer, where the surface layer 11 (in the case where the surface layer 11 itself consists of plural layers, at least the outermost layer) is composed of a fluorinated polyimide resin having an ether group in the main chain.

Examples of the fluorinated polyimide resin having an ether group in the main chain include a resin prepared from a fluorinated polyamic acid synthesized using an at least partially fluorinated acid anhydride and an at least partially fluorinated diamine.

The at least partially fluorinated acid anhydride and the at least partially fluorinated diamine include those having a fluorine group (—F) and/or a perfluoroalkyl group (—CₙF₂ₙ₊₁, wherein n is an integer of 1 or more). In the perfluoroalkyl group (—CₙF₂ₙ₊₁), n is preferably from 1 to 9, and specific examples of the perfluoroalkyl group include —CF₃, —C₂F₅ and —C₃F₇.

Specifically, the at least partially fluorinated acid anhydride include, for examples, those represented by the following chemical formulae (1) to (3).

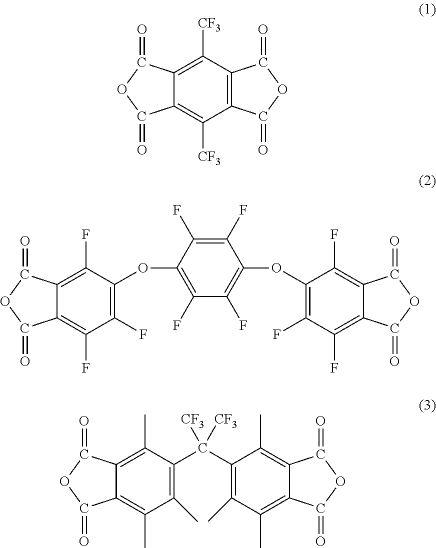

Also, the at least partially fluorinated diamine is generally represented by the following chemical formula (4) and specifically include, for example, those represented by the following chemical formulae (5) to (15).

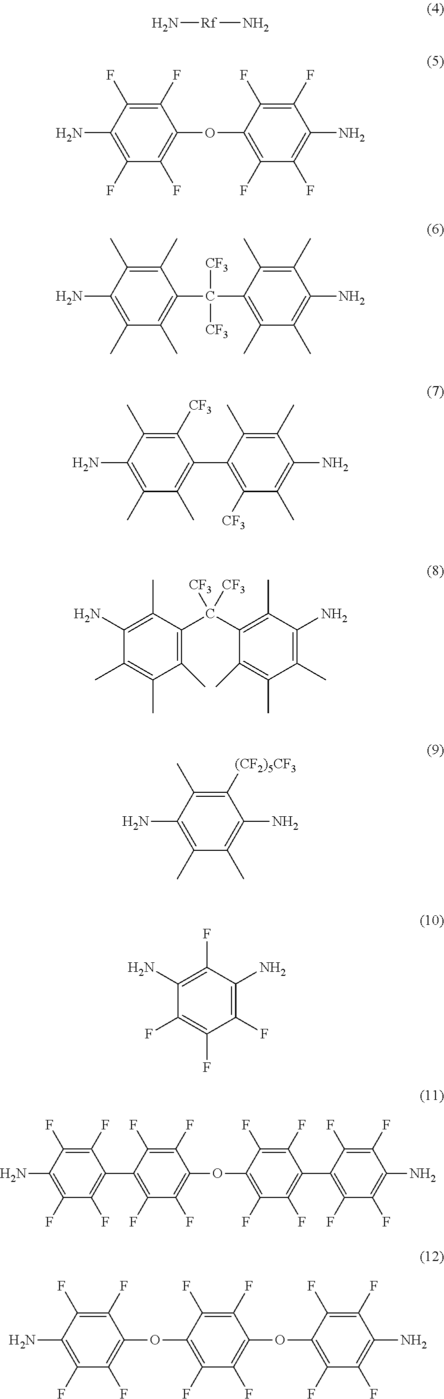

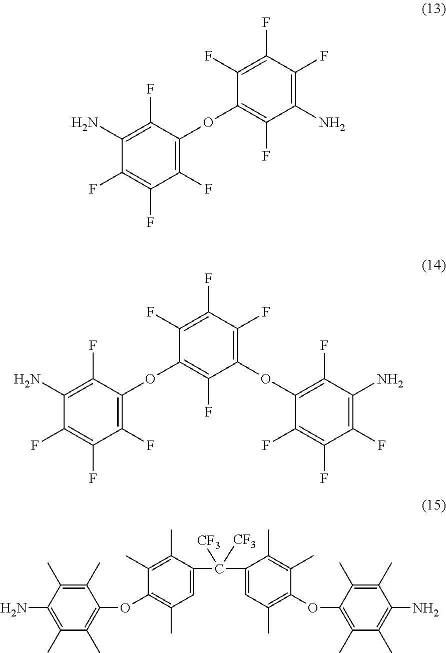

In the formula (4), Rf is a fluorinated aromatic compound.

The above-described at least partially fluorinated acid anhydride and at least partially fluorinated diamines, which may be used in the present invention, may be completely fluorinated or may allow a part to remain as a hydroxyl group (—H) without being fluorinated (without being substituted for by a fluorine group (—F) and/or a perfluoroalkyl group (—CₙF₂ₙ₊₁, wherein n is an integer of 1 or more).

In FIGS. 1A to 1C, as described above, a circularly cylindrical layer is used as the surface layer 11, but the layer may be, for example, in the form of an angular cylinder or an elliptic cylinder. Also, as described above, a surface layer formed from a single layer is shown, but, for example, the surface layer 11 itself may consist of plural layers or may have a single layer configuration where the content of the fluorinated polyimide resin having an ether group in the main chain is increased stepwise or gradiently from the inner side to the outer side. Here, the inner side means a surface on the support side (inner surface) and the outer side means the outer surface. In these cases, the outer surface thereof need to be composed of a fluorinated polyimide resin having an ether group in the main chain.

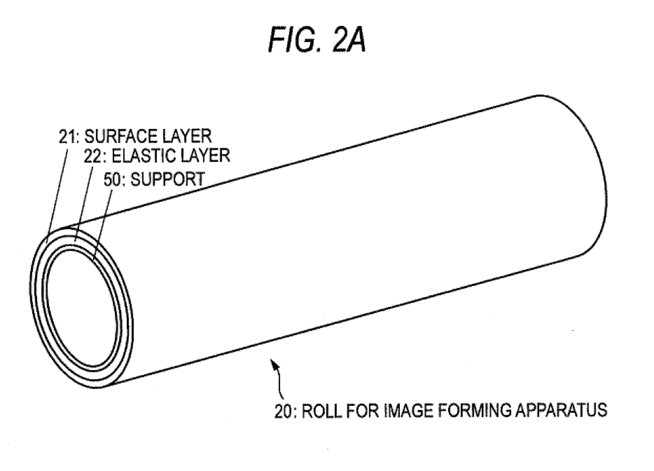

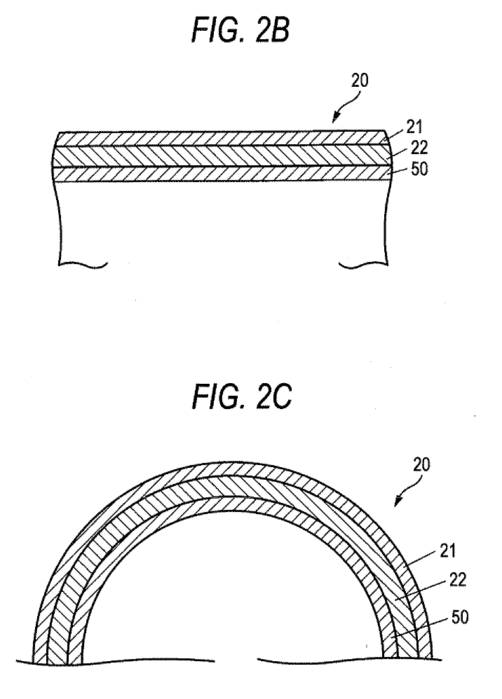

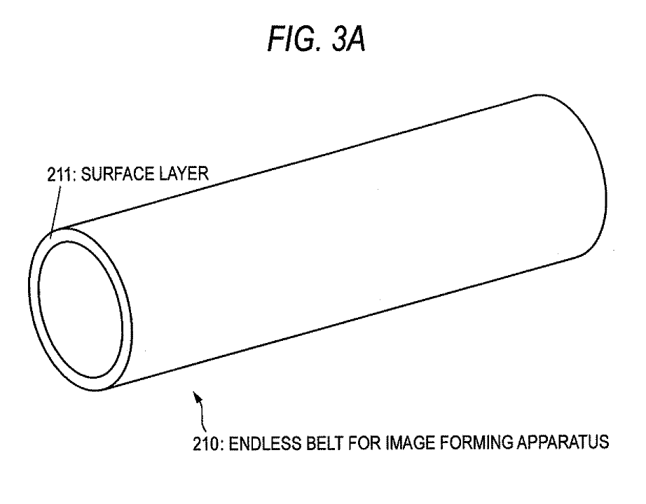

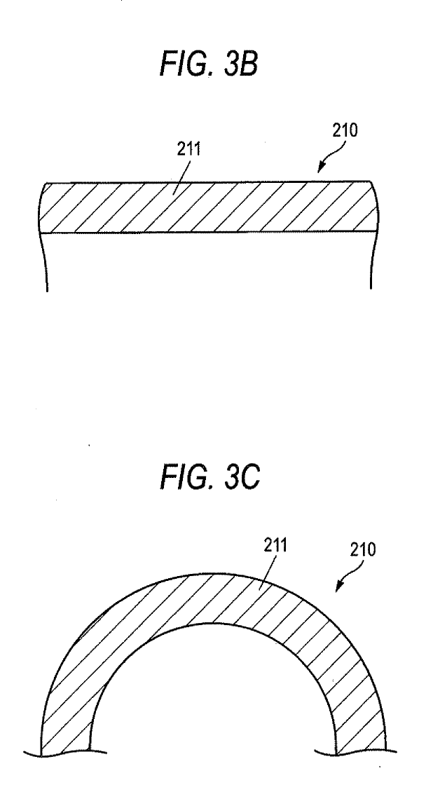

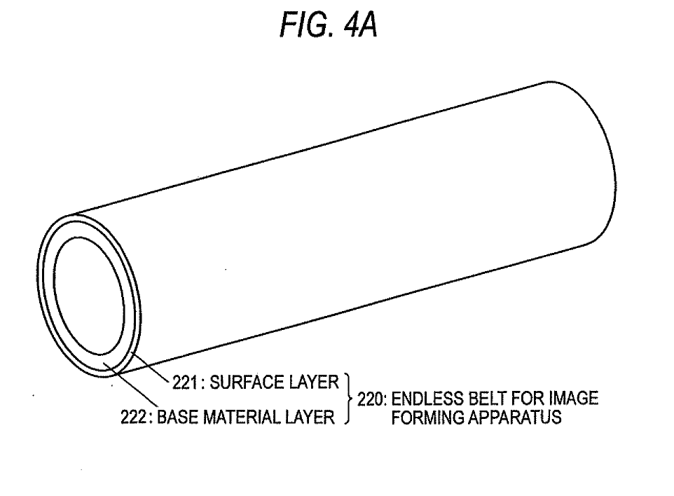

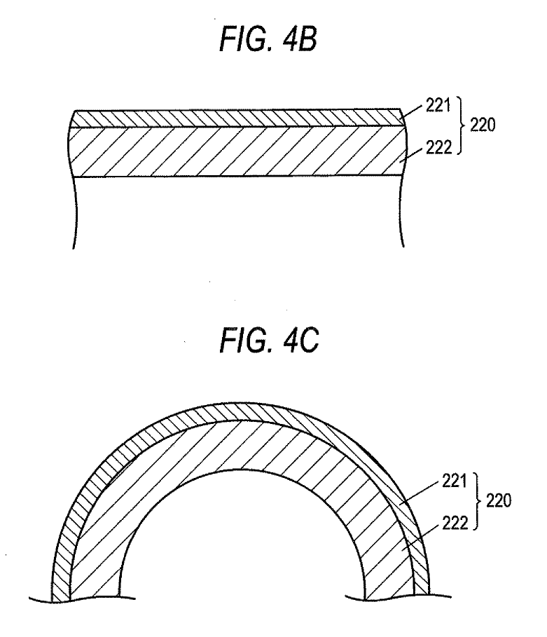

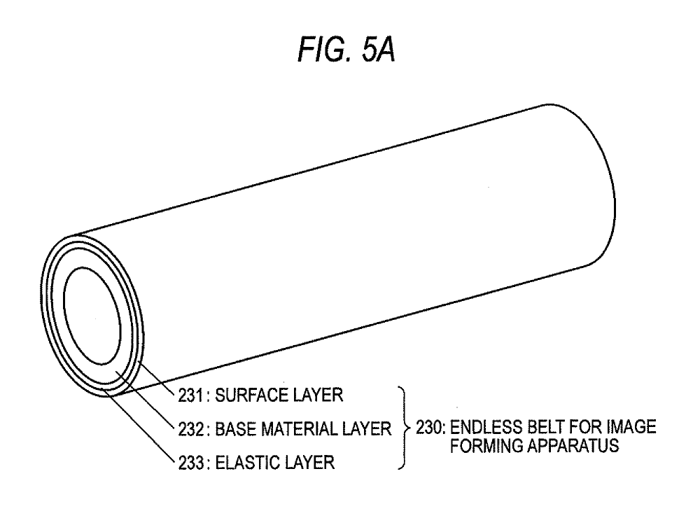

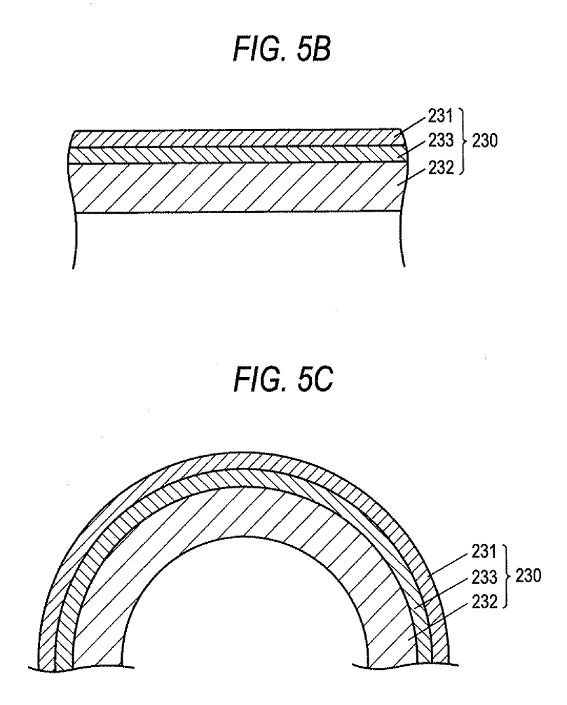

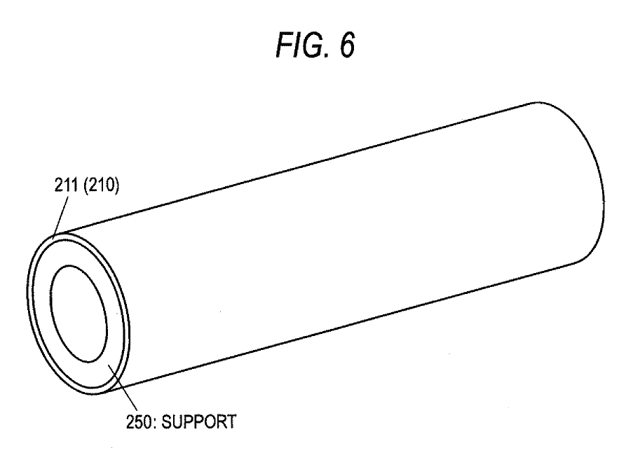

Incidentally, even when the surface layer 11 itself consists of plural layers, the roll 10 for an image forming apparatus in the first exemplary embodiment of the roll for an image forming apparatus does not have, as the layer supported on a support 50 described later, a layer other than the surface layer 11, such as elastic layer 12 (see, FIG. 2A) described later, and therefore, this is included in the case of “when formed from a single layer of a surface layer 11” (that is, the roll 10 for an image forming apparatus does not have other layers such as elastic layer).

The surface layer 11 (in the case where the surface layer 11 itself consists of plural layers, at least the outermost layer) of the roll 10 for an image forming apparatus according to the first exemplary embodiment of the roll for an image forming apparatus is composed of a fluorinated polyimide resin having an ether group in the main chain as described above. Examples of the fluorinated polyimide resin having an ether group in the main chain include a resin prepared from a fluorinated polyamic acid synthesized using a completely fluorinated acid anhydride and a fluorinated diamine.

In the case of using the roll for an image forming apparatus of this exemplary embodiment as a charged body utilizing an electrostatic force, such as transfer roll (e.g., transfer body, transfer (contact-charged) film), an electrically conductive particle can be dispersed in the surface layer 11 of the roll 10 for an image forming apparatus and when producing the roll of this exemplary embodiment by using a PI precursor solution or fluorinated PI precursor solution (fluorinated polyimide varnish) described later, the electrically conductive particle is preferably added to the PI precursor solution or fluorinated PI precursor solution.

Examples of the electrically conductive particle include a carbon-based substance such as carbon black, carbon bead obtained by granulating the carbon black, carbon fiber and graphite, a metal or alloy such as copper, silver and aluminum, an electrically conductive metal oxide such as tin oxide, indium oxide, antimony oxide and SnO₂—In₂O₃ composite oxide, and an electrically conductive whisker such as potassium titanate. Above all, a carbon black particle is preferred, because a predetermined electroconductivity is obtained by its addition in a small amount.

Also, in the case of using the roll for an image forming apparatus of this exemplary embodiment as a fixing roll (e.g., fixing body, fixing film), in order to enhance the releasability of a toner image attached to the outer circumferential surface of the roll 10 for an image forming apparatus, it is also effective to add a fine particle of a resin-coated material having releasability to the PI precursor solution or fluorinated PI precursor solution (fluorinated polyimide varnish).

The resin-coated material having releasability is preferably a fluororesin such as polytetrafluoroethylene (PTFE), tetrafluoroethylene-perfluoroalkyl vinyl ether copolymer (PFA) and tetrafluoroethylene-hexafluoropropylene copolymer (FP). Also, for enhancing the electrostatic offset, a carbon powder may be contained in a dispersed manner.

The fine particle of the above-described fluororesin is preferably a fine particle having an average particle diameter of 0.1 to 5 μm, more preferably a fine particle having an average particle diameter of 0.1 to 1.0 μm.

Also, the surface layer 11 (when the surface layer consists of plural layers, at least the outermost layer) has semiconductivity, and the surface resistivity thereof is preferably from 10⁴ or about 10⁴ to 10¹² or about 10¹² Ω/square, more preferably from 10⁴ or about 10⁴ to 10⁶ or about 10⁶ Ω/square as a fixing roll and from 10⁸ or about 10⁸ to 10¹² or about 10¹² Ω/square as a transfer roll.

Incidentally, the surface resistivity of the surface layer 11 is measured using a circular electrode (e.g., “UR Probe” of Hiresta-IP manufactured by Mitsubishi Petro-Chemical Co., Ltd.) in accordance with JIS K6911.

Furthermore, the surface layer 11 (when the surface layer consists of plural layers, at least the outermost layer) preferably has a film thickness of 0.5 or about 0.5 to 20 or about 20 μm, more preferably a film thickness of 0.5 or about 0.5 to 10 or about 10 μm. If the film thickness is not less than 0.5 μm, the lifetime may not be decreased due to abrasion, whereas if it does not exceed 20 μm, it does not become difficult to cope with thick paper. In addition, the surface layer 11 (when the surface layer consists of plural layers, at least the outermost layer) preferably has a surface roughness Ra of 0.01 to 2 μm, more preferably a surface roughness Ra of 0.01 to 0.5 μm.

Also, in this exemplary embodiment, from the standpoint of suppressing a sliding noise, the surface roughness Ra on the outer circumferential surface (outer surface) of the outermost layer of the surface layer 11 is preferably smaller than the surface roughness Ra on the inner circumferential surface (inner surface) of the innermost layer of the surface layer.

### [Roll for Image Forming Apparatus According to Second Exemplary Embodiment]

FIG. 2A is a perspective view showing a roll (when a multilayer consisting of a surface layer and an elastic layer is supported on a support served as a base layer) for an image forming apparatus according to a second exemplary embodiment of the roll for an image forming apparatus, which is a first preferable aspect of the present invention. FIG. 2B is a longitudinal sectional view of the roll for an image forming apparatus shown in FIG. 2A. Also, FIG. 2C is a transverse sectional view of the roll for an image forming apparatus shown in FIG. 2A.

As shown in FIGS. 2A to 2C, the roll 20 for an image forming apparatus according to a second exemplary embodiment of the roll for an image forming apparatus differs from the roll 10 for an image forming apparatus according to the first exemplary embodiment of the roll for an image forming apparatus in that the layer formed on the support 50 is a multilayer consisting of a surface layer 21 and an elastic layer 22, though the layer is a single layer of a surface layer 11 in the case of the roll 10 for an image forming apparatus according to the first exemplary embodiment of the roll for an image forming apparatus, but for the rest, the roll of this exemplary embodiment is fundamentally the same as that in the first exemplary embodiment of the roll for an image forming apparatus. More specifically, the roll 20 for an image forming apparatus according to the second exemplary embodiment of the roll for an image forming apparatus is a roll 20 for an image forming apparatus, used as a fixing or intermediate transfer roll that fixes or transfers an unfixed or untransferred image on a recording member in an image forming apparatus (not shown) of forming an image on a recording member (not shown), and the roll has a circularly cylindrical elastic layer 22 and has on this elastic layer 22 a cylindrical surface layer 21 coming into contact with a recording member at the fixing or transfer (in other words, the elastic layer 22 is provided on the back surface side of the surface layer 21), wherein the surface layer 21 (in the case where the surface layer 21 itself consists of plural layers, at least the outermost layer) is composed of a fluorinated polyimide resin having an ether group in the main chain. The difference from the first exemplary embodiment of the roll for an image forming apparatus is mainly described below.

The elastic layer 22 used in the roll 20 for an image forming apparatus according to the second exemplary embodiment of the roll for an image forming apparatus is used so as to obtain an image coping with thick paper. In FIGS. 2A to 2C, as described above, a circularly cylindrical layer is used as the elastic layer 22, but the layer may be, for example, in the form of an angular cylinder or an elliptic cylinder. Also, similarly to the surface layer 21, the elastic layer 22 itself may consist of plural layers.

The elastic layer 22 (when the elastic layer consists of plural layers, at least the innermost layer) may be composed of a silicone rubber, a fluororubber or the like. Above all, a silicone rubber and a fluororubber are preferred. As regards the silicone rubber, for example, a silicone rubber such as HTV, LTV and RTV can be suitably used. As regards the fluororubber, for example, a VDF-based fluororubber and a VDF-HFP-based fluororubber (binary or ternary) can be suitably used. The thickness of the elastic layer 22 is preferably from 100 to 3,000 μm, more preferably from 150 to 1,000 μm. If the thickness is less than 100 μm, the deformation followability to an unfixed toner image may be decreased to cause an image defect, whereas if it exceeds 3,000 μm, a long warm-up time may be required at the standby state to incur an increase in the power consumption.

Also, as described above, in the case of using the roll of this exemplary embodiment as a charged body utilizing an electrostatic force, such as transfer roll (e.g., transfer body, transfer (contact-charged) film), an electrically conductive particle may be dispersed in the surface layer 21 and the elastic layer 22 of the roll 20 for an image forming apparatus and when producing the roll of this exemplary embodiment by using a PI precursor solution or fluorinated PI precursor solution (fluorinated polyimide varnish) described later, the electrically conductive particle is preferably added to such a PI precursor solution or a fluorinated PI precursor solution (fluorinated polyimide varnish). That is, in the silicone rubber or fluororubber constituting the elastic layer 22, an electrically conductive particle, an inorganic filler (e.g., SiO₂, BaSO₄) or the like is preferably dispersed. Thanks to such construction, the elastic layer 22 may be improved in the mechanical properties, or its thermal conductivity or electrical conductivity may be enhanced. In this case, an optimal kind and an optimal amount can be appropriately selected.

Examples of the electrically conductive particle include a carbon-based substance such as carbon black, carbon bead obtained by granulating the carbon black, carbon fiber and graphite, a metal or alloy such as copper, silver and aluminum, an electrically conductive metal oxide such as tin oxide, indium oxide, antimony oxide and SnO₂—In₂O₃ composite oxide, and an electrically conductive whisker such as potassium titanate. Above all, a carbon black particle is preferred, because a predetermined electroconductivity is obtained by its addition in a small amount.

### [Support]

The support 50 is served as a base layer and used for supporting the surface layer 11 or 21 or supporting the surface layer 11 or 21 and the elastic layer 12 or 22 of the roll 10 or 20 for an image forming apparatus.

The shape of the support 50 includes a pillar shape such as circular pillar and a cylindrical shape such as circular cylinder. In general, a support having a circular cross-section as described above is suitably used, but those having other cross-sectional shapes such as ellipse may also be used. Incidentally, in this exemplary embodiment, unless otherwise indicated, the term “the support 50 surface” means the outer circumferential surface of a support 50 when the support 50 is cylindrical, or a surface parallel to the axial direction of a pillar when the support 50 is pillar-shaped.

The support 50 is preferably composed of a heat-resistant metal material such as aluminum, iron and stainless steel or, if desired, may be composed of a heat-resistant resin such as polyimide, polyamideimide, polybenzimidazole, liquid crystal polymer and polyphenylene sulfide.

The thickness of the support 50 is not particularly limited but is, for example, preferably from 0.3 to 3 mm, more preferably from 0.3 to 1 mm.

### [Production Method of Roll for Image Forming Apparatus]

The production method of the roll for an image forming apparatus of this exemplary embodiment includes preparing a pillar-shaped or cylindrical support or a laminate having an elastic layer stacked on a support, coating a fluorinated polyamic acid (fluorinated polyimide precursor solution, in other words, fluorinated polyimide varnish) synthesized from a completely fluorinated acid anhydride and a fluorinated diamine on the support or laminate to form a coating film working out to a surface layer (hereinafter sometimes simply referred to as a “fluorinated PI precursor coating film forming step”), and then heating and firing the formed coating film to form a surface layer (hereinafter sometimes simply referred as a “fluorinated PI resin film (surface layer) forming step”). Incidentally, the production method may include, if desired, other steps such as a step for drying the fluorinated PI precursor coating film, in addition to the steps above.

The production method of the roll for an image forming apparatus according to this exemplary embodiment is described below by roughly classifying it into: a case where, as in the first exemplary embodiment, the roll 10 for an image forming apparatus has only a surface layer 11 formed from a fluorinated polyimide single layer on a support 50 (a case where a single film (surface layer) composed of a fluorinated polyimide resin having an ether group in the main chain is formed directly on a support 50); and a case where, as in the second exemplary embodiment of the roll for an image forming apparatus, the roll 20 for an image forming apparatus has plural layers consisting of an elastic layer 22 and a surface layer 21 on a support 50 (a case where an elastic layer 22 is first formed on a support 50, and a fluorinated polyimide resin having an ether group in the main chain is then coated on the laminate consisting of the support 50 and the elastic layer 22 to form a surface layer 21, whereby a roll 20 for an image forming apparatus, having plural layers (elastic layer 22 and surface layer 21) on a support 50 is formed).

### <Case Where Roll for Image Forming Apparatus Has Only Surface Layer on Support>

### (Fluorinated PI Precursor Coating Film Forming Step)

In the fluorinated PI precursor coating film forming step, a fluorinated polyimide precursor solution is used to form a coating film on the support 50 surface. As for the fluorinated polyimide precursor, a completely fluorinated dianhydride represented by chemical formulae (1) and (2) mentioned above and a fluorinated diamine represented by chemical formulae (4) to (15) mentioned above are used. Incidentally, the fluorination ratio of diamine is preferably higher. Also, as for the solvent in which the fluorinated PI precursor is dissolved, a known aprotic polar solvent such as N-methylpyrrolidone, N,N-dimethylacetamide, acetamide and N,N-dimethylformamide can be used. In this connection, the concentration, viscosity and the like of the fluorinated PI precursor solution can be appropriately selected and, if desired, other materials, additives and the like, such as the above-described electrically conductive particle, may be added to the fluorinated PI precursor solution.

The method for coating the fluorinated PI precursor solution on the support 50 surface may vary depending on the shape of the support 50, but there can be used a known method such as a dip coating method of dipping the support 50 in the fluorinated PI precursor solution and then pulling it up, a flow coating method of ejecting the fluorinated PI precursor solution on the support 50 rotating in the circumferential direction from a nozzle or the like provided nearly right above the support 50 while parallelly moving the support 50 or the nozzle in the axial direction, and a blade coating method where in the flow coating method above, the coating film formed on the support 50 surface is metered with a blade. Here, in the flow coating method or blade coating method, the coating film formed on the support 50 surface is spirally formed in the axial direction of the support 50 and therefore, a seam is produced, but since drying of the solvent contained in the fluorinated PI precursor solution proceeds slowly at ordinary temperature, the seam is naturally smoothed.

### (Fluorinated PI Precursor Drying Step)

In the fluorinated PI precursor drying step, the solvent contained in the coating film formed on the support 50 surface is preferably removed by heating/drying. The heating temperature is preferably not more than the boiling point of the solvent used and, for example, the heating temperature is preferably from 70 to 201° C. when the solvent is N-methylpyrrolidone (NMP, boiling point 202° C.) and preferably from 60 to 164° C. when the solvent is dimethylacetamide (DMAC, boiling point: 165° C.). More preferably, the solvent is removed by two-stage heating where the coating film is once heated at 60 to 125° C. that is not more than 125° C. at which imidation starts, thereby removing water being dissolved in the solvent and having an adverse effect on the fluorination, and then heated at a temperature not more than the boiling point of the solvent. The temperature in the second stage is, for example, preferably from 125 to 201° C. when the solvent is N-methylpyrrolidone (NMP, boiling point 202° C.) and preferably from 125 to 164° C. when the solvent is dimethylacetamide (DMAC, boiling point: 165° C.). The heating time varies depending on the concentration and thickness of the coating film coated, but the heating time in each stage is preferably on the order of 10 to 120 minutes. In the case where the coating film formed on the support 50 surface sags during drying by the effect of specific gravity, it is also preferred to heat and dry the coating film while rotating the support 50 at approximately from 10 to 60 rpm by keeping the axial direction on the horizontal.

### (Fluorinated PI Resin Film (Surface Layer) Forming Step)

Formation of the fluorinated PI film by heating the coating film dried through the fluorinated PI precursor drying step is preferably performed in a temperature range of from the boiling point of the solvent to about 400° C. for approximately from 20 to 120 minutes. At this time, the temperature is preferably raised stepwise or slowly at a constant rate until it reaches the above-described temperature. More preferably, heating/film formation is performed at temperatures in two stages or three stages. Incidentally, as the final temperature is higher, a stronger film is formed, and therefore, it is preferred to heat the coating film at 340° C. or more. The thus-obtained roll 10 for an image forming apparatus may be further subjected, if desired, to edge slitting, perforation punching, tape winding and the like.

### <Case Where Roll for Image Forming Apparatus Has Elastic Layer and Surface Layer on Support>

In the case where the roll for an image forming apparatus has an elastic layer 22 and a surface layer 21 on a support, an elastic layer 22 is previously stacked and formed on a pillar-shaped or cylindrical support 50, and a fluorinated polyamic acid (fluorinated polyimide precursor solution, in other words, fluorinated polyimide varnish) produced using a completely fluorinated acid anhydride and a fluorinated diamine is coated on the surface of the elastic body 22 to form a surface layer 21. However, the silicone elastic body usually used as the elastic body 22 has strong water repellency, and the fluorinated polyamic acid even when coated is repelled and cannot be uniformly coated. Therefore, in order to enable formation of a uniform coating film, the surface of the elastic body 22 needs to be hydrophilized. Examples of the method used for hydrophilization include a UV ozone treatment, irradiation of an excimer laser, and coating of a coupling agent corresponding to an adhesive. Among these, irradiation of an excimer laser is excellent as the method for hydrophilization, because a coating film of a highly water-repellent/oil-repellent material may be formed. However, irradiation of an excimer laser is high in cost and is not necessarily satisfied in view of productivity. Therefore, in this exemplary embodiment, instead of irradiation of an excimer laser, a dielectric barrier discharge excimer lamp at a wavelength 172 nm is irradiated while rotating the laminate of the support 50 and the elastic body (silicone elastic body) 22, whereby the hydrophilization treatment can be realized at a lower cost with higher productivity than using excimer laser. The elastic body (silicone elastic body) 22 surface irradiated with an excimer lamp at 172 nm is hydrophilized resulting from breaking of a covalent bond between Si and O.

After hydrophilizing the elastic body surface (hereinafter sometimes simply referred to as a “elastic body surface hydrophilizing step”), similarly to the “Case Where Roll for Image Forming Apparatus Has Only Surface Layer on Support”, a fluorinated PI resin film (surface layer 21) is formed through the “fluorinated PI precursor coating film forming step”, “fluorinated PI precursor drying step”, “fluorinated PI resin film (surface layer) forming step” and the like, whereby a roll 20 for an image forming apparatus is obtained. The thus-obtained roll 20 for an image forming apparatus may be further subjected, if desired, to edge slitting, perforation punching, tape winding and the like. The “elastic body surface hydrophilizing step” is described in more detail below.

### (Elastic Body Surface Hydrophilizing Step)

In the case of using a silicone elastic body as the elastic body 22, the silicone elastic body has high water repellency and without applying a surface treatment thereto, a material for forming a surface layer 21 can be hardly coated. Therefore, it is necessary to break the covalent bond between Si and O and hydrophilize the surface, but the covalent bond force of Si to O is as large as 105.4 kcal/mol, and its breaking requires strong energy. Accordingly, high-intensity light energy with short wavelength is necessary. For the surface modification, a method using a dielectric barrier discharge excimer lamp at a wavelength of 172 nm, where the excimer lamp is irradiated while rotating a roll with a silicone elastic body at a constant rate, is preferably used. The surface is treated while rotating the roll at a constant rate, so that the entire surface of the elastic layer 22 may be uniformly surface-modified. Incidentally, the light at a wavelength of 172 nm is abruptly attenuated in the atmosphere and therefore, the distance between the irradiation surface of the lamp and the surface of the elastic layer 22 is preferably set to be as small as possible. A distance of 1 to 10 mm is often used. In this connection, the light intensity is less attenuated in an oxygen-free state under a vacuum atmosphere or a nitrogen atmosphere, virtually eliminating the limit on the distance between the irradiation surface of the lamp and the surface of the elastic layer 22. Here, an excimer laser may also be used in place of the excimer lamp.

After the “elastic body surface hydrophilizing step”, similarly to the “Case Where Roll for Image Forming Apparatus Has Only Surface Layer on Support”, a fluorinated PT resin film (surface layer 21) is formed through the “fluorinated PI precursor coating film forming step”, “fluorinated PI precursor drying step”, “fluorinated PI resin film (surface layer) forming step” and the like, whereby a roll 20 for an image forming apparatus is obtained. In the “fluorinated PI resin film (surface layer) forming step”, when the heat resistance of the elastic body 22 coated is insufficient, insofar as the heating temperature is a temperature allowing an imidation reaction to proceed and being not lower than the boiling point of the solvent, a fluorinated PI resin film (surface layer) may be formed. For example, in the case of using NMP as the solvent, the temperature may be sufficient if it is 202° C. or more, and in turn, the heat resisting temperature of the elastic body 22 coated becomes at least 202° C.

### [Image Forming Apparatus]

An image forming apparatus using the roll for an image forming apparatus of this exemplary embodiment is described below. The image forming apparatus of this exemplary embodiment may be any image forming apparatus as long as it is a known image forming apparatus capable of utilizing the roll for an image forming apparatus of this exemplary embodiment, but, for example, an image fixing apparatus having the following configuration is described below.

The image forming apparatus (image fixing apparatus) of this exemplary embodiment includes a heat-fixing roll used as the fixing roll of this exemplary embodiment and an endless belt or the like tensioned by a roll group such as pressure roll. The heat-fixing roll has, for example, a halogen lamp with an output of 850 W as a heating source provided in the inside thereof. Also, a temperature sensor is optionally disposed on its surface and measures the surface temperature, whereby the halogen lamp is feedback-controlled by a temperature controller based on the measurement signal and the surface of the heat-fixing roll is adjusted to 150 to 180° C. In the case of using this image fixing apparatus, a toner image is transferred on a recording member such as recording paper by a transfer device, the recording member is then conveyed to the fixing roll, and the toner image is fixed on the recording member by the pressure applied from the pressure roll and the heat applied from the halogen lamp.

### Second Preferable Aspect

### [Endless Belt for Image Forming Apparatus According to First Exemplary Embodiment]

FIG. 3A is a perspective view showing an endless belt (when formed from a single layer of a surface layer) for an image forming apparatus according to a first exemplary embodiment of the endless belt for an image forming apparatus, which is a second preferable aspect of the present invention. FIG. 3B is a longitudinal sectional view of the endless belt for an image forming apparatus shown in FIG. 3A. Also, FIG. 30 is a transverse sectional view of the endless belt for an image forming apparatus shown in FIG. 3A.

As shown in FIGS. 3A to 3C, the endless belt 210 for an image forming apparatus according to a first exemplary embodiment of the endless belt for an image forming apparatus of the present invention is an endless belt 210 for an image forming apparatus, used as a fixing or intermediate transfer belt for fixing or transferring an unfixed or untransferred image on a recording member in an image forming apparatus (not shown) of forming an image on a recording member (not shown), and the endless belt has a cylindrical surface layer 211 coming into contact with a recording member at the fixing or transfer, wherein at least the outer surface of the surface layer 211 is composed of a fluorinated polyimide resin having an ether group in the main chain.

In FIGS. 3A to 3C, as described above, a circularly cylindrical layer is used as the surface layer 211, but the layer may be, for example, in the form of a cylinder such as angular cylinder and elliptic cylinder or a pillar such as circular pillar. Also, as described above, a surface layer formed from a single layer is shown, but, for example, the surface layer 211 itself may consist of plural layers or may have a single layer configuration where the content of the fluorinated polyimide resin having an ether group in the main chain is increased stepwise or gradiently from the inner side to the outer side. Here, the inner side means a surface on the base material layer side (inner surface) and the outer side means the outer surface. In these cases, the outer surface thereof must be composed of a fluorinated polyimide resin having an ether group in the main chain.

Incidentally, even when the surface layer 211 itself consists of plural layers, the endless belt 210 for an image forming apparatus in the first exemplary embodiment of the endless belt for an image forming apparatus does not have a layer other than the surface layer 211, such as base material layer 222 (see, FIG. 4A) described later, and therefore, this is included in the case of “when formed from a single layer of a surface layer 211” (that is, the endless belt 210 does not have other layers such as base material layer).

At least the outer surface of the surface layer 211 of the endless belt 210 for an image forming apparatus according to the first exemplary embodiment of the endless belt for an image forming apparatus is composed of a fluorinated polyimide resin having an ether group in the main chain as described above. Examples of the fluorinated polyimide resin having an ether group in the main chain include a resin prepared from a fluorinated polyamic acid synthesized using an at least partially fluorinated acid anhydride and an at least partially fluorinated diamine.

The at least partially fluorinated acid anhydride and the at least partially fluorinated diamine include those having a fluorine group (—F) and/or a perfluoroalkyl group (—CₙF₂ₙ₊₁, wherein n is an integer of 1 or more). In the perfluoroalkyl group (—CₙF₂ₙ₊₁), n is preferably from 1 to 9, and specific examples of the perfluoroalkyl group include —CF₃, —C₂F₅ and —C₃F₇.

Specifically, the at least partially fluorinated acid anhydride include, for examples, those represented by chemical formulae (1) to (3) mentioned above.

Also, the at least partially fluorinated diamine is generally represented by chemical formula (4) mentioned above and specifically include, for example, those represented by chemical formulae (5) to (15) mentioned above.

The above-described at least partially fluorinated acid anhydride and at least partially fluorinated diamines, which may be used in the present invention, may be completely fluorinated or may allow a part to remain as a hydroxyl group (—H) without being fluorinated (without being substituted for by a fluorine group (—F) and/or a perfluoroalkyl, group (—CₙF₂ₙ₊₁, wherein n is an integer of 1 or more).

The surface layer 211 (when the surface layer consists of plural layers, at least the outermost layer) may have semiconductivity, and the surface resistivity thereof is preferably from 10⁴ or about 10⁴ to 10¹² or about 10¹² Ω/square, more preferably from 10⁴ or about 10⁴ to 10⁶ or about 10⁶ Ω/square as a fixing belt and from 10⁸ or about 10⁸ to 10¹² or about 10¹² Ω/square as a transfer belt. Incidentally, the surface resistivity of the surface layer 211 is measured using a circular electrode (e.g., “UR Probe” of Hiresta-IP manufactured by Mitsubishi Petro-Chemical Co., Ltd.) in accordance with JIS K6911.

In the case of using the endless belt for an image forming apparatus of this exemplary embodiment as a charged body utilizing an electrostatic force, such as transfer belt (e.g., transfer body, transfer (contact-charged) film), an electrically conductive particle can be dispersed in the surface layer 211 of the endless belt 210 for an image forming apparatus and when producing the endless belt of this exemplary embodiment by using a PI precursor solution or fluorinated PI precursor solution (fluorinated polyimide varnish) described later, the electrically conductive particle is preferably added to the PI precursor solution or fluorinated PI precursor solution.

Examples of the electrically conductive particle include a carbon-based substance such as carbon black, carbon bead obtained by granulating the carbon black, carbon fiber and graphite, a metal or alloy such as copper, silver and aluminum, an electrically conductive metal oxide such as tin oxide, indium oxide, antimony oxide and SnO₂—In₂O₃ composite oxide, and an electrically conductive whisker such as potassium titanate. Above all, a carbon black particle is preferred, because a predetermined electroconductivity is obtained by its addition in a small amount.

Also, in the case of using the endless belt for an image forming apparatus of this exemplary embodiment as a fixing belt (e.g., fixing body, fixing film), in order to enhance the releasability of a toner image attached to the outer circumferential surface of the endless belt 210 for an image forming apparatus, it is also effective to add a fine particle of a resin-coated material having releasability to the PI precursor solution or fluorinated PI precursor solution.

The resin-coated material having releasability is preferably a fluororesin such as polytetrafluoroethylene (PTFE), tetrafluoroethylene-perfluoroalkyl vinyl ether copolymer (PFA) and tetrafluoroethylene-hexafluoropropylene copolymer (FEP). Also, for enhancing the electrostatic offset, a carbon powder may be contained in a dispersed manner.

Furthermore, the surface layer 211 (when the surface layer consists of plural layers, at least the outermost layer) preferably has a film thickness of 0.5 or about 0.5 to 20 or about 20 μm more preferably a film thickness of 0.5 or about 0.5 to 10 or about 10 μm. If the film thickness is not less than 0.5 μm, the lifetime may not be decreased due to abrasion, whereas if it does not exceed 20 μm, it does not become difficult to cope with thick paper.

In this exemplary embodiment, the surface roughness Ra in the axial direction on the inner circumferential surface (inner surface) of the innermost layer of the surface layer 211 is preferably from 0.5 to 3.0 μm, more preferably from 0.8 to 2.5 μm, and at the same time, the surface roughness Ra in the circumferential direction on the inner circumferential surface is preferably from 0.01 to 0.5 μm, more preferably from 0.01 to 0.3 μm.

Also, in this exemplary embodiment, from the standpoint of suppressing a sliding noise, the surface roughness Ra on the outer circumferential surface (outer surface) of the outermost layer of the surface layer 211 is preferably smaller than the surface roughness Ra on the inner circumferential surface (inner surface) of the innermost layer of the surface layer.

### [Endless Belt for Image Forming Apparatus According to Second Exemplary Embodiment]

FIG. 4A is a perspective view showing an endless belt (when formed from a multilayer consisting of a surface layer and a base material layer which is served as a base layer) for an image forming apparatus according to a second exemplary embodiment of the endless belt for an image forming apparatus, which is a second preferable aspect of the present invention. FIG. 4B is a longitudinal sectional view of the endless belt for an image forming apparatus shown in FIG. 4A. Also, FIG. 4C is a transverse sectional view of the endless belt for an image forming apparatus shown in FIG. 4A.

As shown in FIGS. 4A to 4C, the endless belt 220 for an image forming apparatus according to a second exemplary embodiment of the endless belt for an image forming apparatus differs from the endless belt 210 (which is formed from a single layer) for an image forming apparatus according to the first exemplary embodiment of the endless belt for an image forming apparatus in that the endless belt of this exemplary embodiment is formed from a multilayer consisting of a surface layer and a base material layer, but the rest is fundamentally the same as in the first exemplary embodiment of the endless belt for an image forming apparatus. More specifically, the endless belt 220 for an image forming apparatus according to the second exemplary embodiment of the endless belt for an image forming apparatus is an endless belt 220 for an image forming apparatus, used as a fixing or intermediate transfer belt for fixing or transferring an unfixed or untransferred image on a recording member in an image forming apparatus (not shown) of forming an image on a recording member (not shown), and the endless belt has a circularly cylindrical base material layer 222 served as a base layer and has on this base material layer 222 a cylindrical surface layer 221 coming into contact with a recording member at the fixing or transfer (in other words, the base material layer 222 is provided on the back surface side of the surface layer 221), wherein at least the outer surface of the surface layer 221 is composed of a fluorinated polyimide resin having an ether group in the main chain. The difference from the first exemplary embodiment of the endless belt for an image forming apparatus is mainly described below.

The base material layer 222 used in the endless belt 220 for an image forming apparatus according to the second exemplary embodiment of the endless belt for an image forming apparatus may share the function with the surface layer 221 requiring releasability and thereby reduce the amount of a material used while maintaining a given strength and therefore, is used for suppressing a rise in cost when an expensive fluorinated polyimide resin is used. In FIGS. 4A to 4C, as described above, a circularly cylindrical layer is used as the base material layer 222, but the layer may be, for example, in the form of a cylinder such as angular cylinder or elliptic cylinder or a pillar such as circular pillar. Also, similarly to the surface layer 221, the base material layer 222 itself may consist of plural layers. The thickness of the base material layer 222 is preferably from 10 to 100 μm, more preferably from 20 to 80 μm. If the thickness is not less than 10 μm, the base material layer may not lack the strength, whereas if it does not exceed 100 μm, the flexibility may be sufficient.

In view of adhesion, at least the inner surface (having the same meaning as the outer surface in the surface layer 221) of the base material layer 222 is preferably composed of polyimide or polyimide.

Also, as described above, in the case of using the endless belt of this exemplary embodiment as a charged body utilizing an electrostatic force, such as transfer endless belt (e.g., transfer body, transfer (contact-charged) film), an electrically conductive particle may be dispersed in the surface layer 221 and the base material layer 222 of the endless belt 220 and when producing the endless belt of this exemplary embodiment by using a PI precursor solution or fluorinated PI precursor solution described later, the electrically conductive particle is preferably added to the PI precursor solution or fluorinated PI precursor solution. That is, an electrically conductive particle is preferably dispersed in the polyimide or polyamide constituting the base material layer 222.

Examples of the electrically conductive particle include a carbon-based substance such as carbon black, carbon bead obtained by granulating the carbon black, carbon fiber and graphite, a metal or alloy such as copper, silver and aluminum, an electrically conductive metal oxide such as tin oxide, indium oxide, antimony oxide and SnO₂—In₂O₃ composite oxide, and an electrically conductive whisker such as potassium titanate. Above all, a carbon black particle is preferred, because a predetermined electroconductivity is obtained by its addition in a small amount.

In the second exemplary embodiment of the endless belt for an image forming apparatus, the surface roughness Ra in the axial direction on the inner surface of the base material layer 222 is preferably from 0.5 to 3.0 μm, more preferably from 0.8 to 2.5 μm, and at the same time, the surface roughness Ra in the circumferential direction on the inner circumferential surface is preferably from 0.01 to 0.5 μm, more preferably from 0.01 to 0.3 μm.

Also, in this exemplary embodiment, from the standpoint of suppressing a sliding noise, the surface roughness Ra on the outer surface of the surface layer 221 is preferably smaller than the surface roughness Ra on the inner surface of the base material layer 222.

### [Endless Belt for Image Forming Apparatus According to Third Exemplary Embodiment]

FIG. 5A is a perspective view showing an endless belt (when formed from a multilayer consisting of a surface layer, a base material layer which is served as a base layer and an elastic layer) for an image forming apparatus according to a third exemplary embodiment of the endless belt for an image forming apparatus, which is a second preferable aspect of the present invention. FIG. 5B is a longitudinal sectional view of the endless belt for an image forming apparatus shown in FIG. 5A. Also, FIG. 5C is a transverse sectional view of the endless belt for an image forming apparatus shown in FIG. 5A.

As shown in FIGS. 5A to 5C, the endless belt 230 for an image forming apparatus according to a third exemplary embodiment of the endless belt for an image forming apparatus differs from the endless belt 220 (which is formed from a single layer) for an image forming apparatus according to the first exemplary embodiment of the endless belt for an image forming apparatus in that the endless belt of this exemplary embodiment is formed from a multilayer consisting of a surface layer, a base material layer and an elastic layer, but the rest is fundamentally the same as in the first and second exemplary embodiments of the endless belt for an image forming apparatus. More specifically, the endless belt 230 for an image forming apparatus according to the third exemplary embodiment of the endless belt for an image forming apparatus is an endless belt 230 for an image forming apparatus, used as a fixing or intermediate transfer belt for fixing or transferring an unfixed or untransferred image on a recording member in an image forming apparatus (not shown) of forming an image on a recording member (not shown), and the endless belt has a circularly cylindrical base material layer 232 served as a base layer, has on this base material layer 232 a cylindrical surface layer 231 coming into contact with a recording member at the fixing or transfer (in other words, the base material layer 232 is provided on the back surface side of the surface layer 231), and further has an elastic layer 233 as an intermediate layer between the surface layer 231 and the base material layer 232, wherein at least the outer surface of the surface layer 231 is composed of a fluorinated polyimide resin having an ether group in the main chain. The difference from the first and second exemplary embodiments of the endless belt for an image forming apparatus is mainly described below.

The elastic layer 233 used in the endless belt 230 for an image forming apparatus according to the third exemplary embodiment of the endless belt for an image forming apparatus is used to enhance the fixing property to thick paper or the like. In FIGS. 5A to 5C, as described above, a circularly cylindrical layer is used as the elastic layer 233, but the layer may be, for example, in the form of a cylinder such as angular cylinder and elliptic cylinder or a pillar such as circular pillar. Also, similarly to the surface layer 231, the elastic layer 233 itself may consist of, for example, plural layers.

The elastic layer 233 is preferably, for example, silicone rubber or fluororubber in view of heat resistance, cost and the like.

### [Support]

FIG. 6 is a perspective view showing a state where the endless belt for an image forming apparatus in the first exemplary embodiment of the endless belt for an image forming apparatus shown in FIG. 3A is supported by a support.

The support 250 is used for supporting the endless belt in producing or using the endless belt for an image forming apparatus of this exemplary embodiment.

The shape of the support 250 includes a pillar shape such as circular pillar and a cylindrical shape such as circular cylinder. In general, a support having a circular cross-section as described above is suitably used, but those having other cross-sectional shapes such as ellipse may also be used. The thickness of the support 250 is not particularly limited but is, for example, preferably from 0.3 to 3 mm, more preferably from 0.3 to 1 mm. Incidentally, in this exemplary embodiment, unless otherwise indicated, the term “support 250 surface” means the outer surface of a support 250 when the support 250 is cylindrical, or a surface parallel to the axial direction of a pillar when the support 250 is pillar-shaped.

The material of the support 250 is preferably a metal such as aluminum, copper and stainless steel. In this case, for enhancing the releasability of the support 250 surface, the support 250 surface may be plated using chromium or nickel, the support 250 surface may be coated with fluororesin or silicone resin, or a release agent may be coated on the support 250 surface.

On the other hand, in the case of producing the endless belt for an image forming apparatus of this invention, a coating film is formed on the support 250 surface and the formed coating film is heated. At this time, swelling or defect is sometimes generated in the PI resin film due to a gas produced by vaporization of a solvent or the like remaining in the coating film. Therefore, in order to effectively expel a gas generated in the coating film at the heat treatment, blasting work may be applied to the support 250 surface, thereby forming a rough surface with a surface roughness Ra of approximately from 0.8 to 1.0 μm in the support 250 surface, or cutting work may be applied in the circumferential direction of the support 250 surface.

By subjecting the support 250 surface to cutting work in the circumferential direction, the above-described performance of expelling gas is ensured and at the same time, the surface roughness Ra in the circumferential direction on the inner surface of the endless belt may be made smaller than the surface roughness Ra in the axial direction on the inner surface.

The term “cutting work in the circumferential direction” includes not only a sate where the cut line formed in the support 250 surface by cutting work is substantially parallel to the circumferential direction of the support 250 but also a state where the cut line is formed in a slightly oblique manner with respect to the circumferential direction. Also, the cut line formed in the support 250 surface may only a cut line making a substantially constant angle to the circumferential direction or may be a mixture of those making plural angles.

In order to ensure the gas expelling performance and at the same time, let the surface roughness Ra in the circumferential direction on the inner surface of the endless belt produced be smaller than in the axial direction on the inner surface of the endless belt, the cutting work is preferably applied in the circumferential direction of the support 250 surface such that the surface roughness Ra in the acetal direction on the support 250 surface is from 0.5 to 2.5 μm and the surface roughness Ra in the circumferential direction on the support 250 surface is smaller than the surface roughness Ra in the axial direction on the support 250 surface.

The surface roughness Ra in the circumferential direction on the support 250 surface is not particularly limited as long as it is smaller than the surface roughness Ra in the axial direction on the support 250 surface, but this surface roughness is preferably 0.5 μm or less, because when used in an electrophotographic device, the endless belt may be reduced in the load (torque) at its rotation. Incidentally, the surface roughness Ra is an arithmetic average roughness as a measure of roughness and can be measured using a known stylus-type surface roughness Ra tester (e.g., Surfcom 1400A, manufactured by Tokyo Seimitsu Co., Ltd.).

### [Production Method of Endless Belt for Image Forming Apparatus]

The production method of the endless belt for an image forming apparatus of this exemplary embodiment includes preparing a fluorinated polyamic acid (fluorinated polyimide precursor solution) synthesized from an at least partially fluorinated acid anhydride and an at least partially fluorinated diamine, coating the prepared fluorinated polyamic acid (fluorinated polyimide precursor solution) on a base material to form a coating film (hereinafter sometimes simply referred to as a “fluorinated PI precursor coating film forming step”), and then heating the formed coating film (hereinafter sometimes simply referred as a “fluorinated PI resin film (surface layer) forming step”). Incidentally, the production method may include, if desired, other steps such as a step for drying the fluorinated PI precursor coating film, in addition to the steps above.

The production method of the endless belt for an image forming apparatus according to this exemplary embodiment is described below by roughly classifying it into: a case where, as in the first exemplary embodiment of the endless belt for an image forming apparatus, the endless belt has only a surface layer formed from a fluorinated polyimide resin single layer (a case where a single film (surface layer) composed of a fluorinated polyimide resin having an ether group in the main chain is formed directly on a metal-made support 250); and a case where, as in the second or third exemplary embodiment of the endless belt for an image forming apparatus, the endless belt has plural layers such as surface layer (which is formed from a fluorinated polyimide single layer) and base material layer (a case where a fluorinated polyimide resin having an ether group in the main chain is coated on an existing endless support composed of polyimide to form an endless belt having plural layers).

<Case Where Endless Belt Has Only Surface Layer Formed from Fluorinated Polyimide Resin Single Layer>

### (Fluorinated PI Precursor Coating Film Forming Step)

In the fluorinated PI precursor coating film forming step, a fluorinated polyimide precursor solution is used to form a coating film on the support 250 surface. As for the fluorinated polyimide precursor, an at least partially fluorinated acid anhydride represented by chemical formulae (1) to (3) mentioned above and an at least partially fluorinated diamine represented by chemical formula (4) mentioned above, specifically, represented by chemical formulae (5) to (15) mentioned above, are used. Incidentally, the fluorination ratio of diamine is preferably higher. Also, as for the solvent in which the fluorinated PI precursor is dissolved, a known aprotic polar solvent such as N-methylpyrrolidone, N,N-dimethylacetamide, acetamide and N,N-dimethylformamide can be used. In this connection, the concentration, viscosity and the like of the fluorinated PI precursor solution can be appropriately selected and, if desired, other materials, additives and the like, such as the above-described electrically conductive particle, may be added to the fluorinated PI precursor solution.

The method for coating the fluorinated PI precursor solution on the support 250 surface may vary depending on the shape of the support 250, but there can be used a known method such as a dip coating method of dipping the support 250 in the fluorinated PI precursor solution and then pulling it up, a flow coating method of ejecting the fluorinated PI precursor solution on the support 250 rotating in the circumferential direction from a nozzle or the like provided nearly right above the support 250 while parallelly moving the support 250 or the nozzle in the axial direction, and a blade coating method where in the flow coating method above, the coating film formed on the support 250 surface is metered with a blade. Here, in the flow coating method or blade coating method, the coating film formed on the support 250 surface is spirally formed in the axial direction of the support 250 and therefore, a seam is produced, but since drying of the solvent contained in the fluorinated PI precursor solution proceeds slowly at ordinary temperature, the seam is naturally smoothed.

### (Fluorinated PI Precursor Drying Step)

In the fluorinated PI precursor drying step, the solvent contained in the coating film formed on the support 250 surface is preferably removed by heating/drying. The heating temperature is preferably not more than the boiling point of the solvent used and, for example, the heating temperature is preferably from 70 to 201° C. when the solvent is N-methylpyrrolidone (NMP, boiling point 202° C.) and preferably from 60 to 164° C. when the solvent is dimethylacetamide (DMAC, boiling point: 165° C.). More preferably, the solvent is removed by two-stage heating where the coating film is once heated at 60 to 125° C. that is not more than 125° C. at which imidation starts, thereby removing water being dissolved in the solvent and having an adverse effect on the fluorination, and then heated at a temperature not more than the boiling point of the solvent. The temperature in the second stage is, for example, preferably from 125 to 201° C. when the solvent is N-methylpyrrolidone (NMP, boiling point 202° C.) and preferably from 125 to 164° C. when the solvent is dimethylacetamide (DMAC, boiling point: 165° C.). The heating time varies depending on the concentration and thickness of the coating film coated, but the heating time in each stage is preferably on the order of 10 to 120 minutes. In the case where the coating film formed on the support 250 surface sags during drying by the effect of specific gravity, it is also preferred to heat and dry the coating film while rotating the support 250 at approximately from 10 to 60 rpm by keeping the axial direction on the horizontal.

### (Fluorinated PI Resin Film (Surface Layer) Forming Step)

Formation of the fluorinated PI film by heating the coating film dried through the fluorinated PI precursor drying step is preferably performed in a temperature range of from the boiling point of the solvent to about 400° C. for approximately from 20 to 120 minutes. At this time, the temperature is preferably raised stepwise or slowly at a constant rate until it reaches the above-described temperature. More preferably, heating/film formation is performed at temperatures in two stages or three stages. Incidentally, as the final temperature is higher, a stronger film is formed, and therefore, it is preferred to heat the coating film at 340° C. or more. Next, the PI resin film (surface layer 211) formed on the support 250 surface through the heating step above is separated from the support 250 to obtain an endless belt 210. The thus-obtained endless belt 210 may be further subjected, if desired, to edge slitting, perforation punching, tape winding and the like.

### <Case Where Endless Belt is Formed From Plural Layers Consisting of Surface Layer and Base Material Layer>

### (PI Precursor Coating Film Forming Step)

In the PI precursor coating film forming step, a polyimide precursor solution is used to form a coating film on the support 250 surface. As for the PI precursor contained in the polyimide precursor solution, a known polyimide precursor can be used. Also, as for the solvent in which the PI precursor is dissolved, a known aprotic polar solvent such as N-methylpyrrolidone, N,N-dimethylacetamide, acetamide and N,N-dimethylformamide can be used. In this connection, the concentration, viscosity and the like of the PI precursor solution can be appropriately selected and, if desired, other materials, additives and the like, such as electrically conductive particle, may be added to the PI precursor solution.

The method for coating the PI precursor solution on the support 250 surface may vary depending on the shape of the support 250, but there can be used a known method such as a dip coating method of dipping the support 250 in the PI precursor solution and then pulling it up, a flow coating method of ejecting the PI precursor solution on the support 250 rotating in the circumferential direction from a nozzle or the like provided nearly right above the support 250 while parallelly moving the support 250 or the nozzle in the axial direction, and a blade coating method where in the flow coating method above, the coating film formed on the support 250 surface is metered with a blade. Here, in the flow coating method or blade coating method, the coating film formed on the support 250 surface is spirally formed in the axial direction of the support 250 and therefore, a seam is produced, but since drying of the solvent contained in the PI precursor solution proceeds slowly at ordinary temperature, the seam is naturally smoothed.

### (PI Precursor Drying Step)

In the PI precursor drying step, the solvent contained in the coating film formed on the support 250 surface as above is preferably removed by heating/drying. The heating temperature is preferably not more than the boiling point of the solvent used and, for example, the heating temperature is preferably from 70 to 201° C. when the solvent is N-methylpyrrolidone (NMP, boiling point 202° C.) and preferably from 60 to 164° C. when the solvent is dimethylacetamide (DMAC, boiling point: 165° C.). More preferably, the solvent is removed by two-stage heating where the coating film is once heated at 60 to 125° C. that is not more than 125° C. at which imidation starts, thereby removing water being dissolved in the solvent and having an adverse effect on the fluorination, and then heated at a temperature not more than the boiling point of the solvent. The temperature in the second stage is, for example, preferably from 125 to 201° C. when the solvent is N-methylpyrrolidone (NMP, boiling point 202° C.) and preferably from 125 to 164° C. when the solvent is dimethylacetamide (DMAC, boiling point: 165° C.). The heating time varies depending on the concentration and thickness of the coating film coated, but the heating time in each stage is preferably on the order of 10 to 120 minutes. In the case where the coating film formed on the support 250 surface sags during drying by the effect of specific gravity, it is also preferred to heat and dry the coating film while rotating the support 250 at approximately from 10 to 60 rpm by keeping the axial direction on the horizontal.

### (PI Resin Film (Base Material Layer) Forming Step)

Formation of the PI resin film (base material layer 222) by heating the coating film dried through the PT precursor drying step is preferably performed in a temperature range of from the boiling point of the solvent to about 400° C. for approximately from 20 to 120 minutes. At this time, the temperature is preferably raised stepwise or slowly at a constant rate until it reaches the above-described temperature. More preferably, heating/film formation is performed at temperatures in two stages or three stages. Incidentally, as the final temperature is higher, a stronger film is formed, and therefore, it is preferred to heat the coating film at 340° C. or more.

### (Fluorinated PI Precursor Coating Film Forming Step)

Next, a fluorinated PI precursor coating film is formed on the PI resin film (base material layer 222) surface. As for the fluorinated polyimide precursor, an at least partially fluorinated acid anhydride represented by chemical formulae (1) to (3) and an at least partially fluorinated diamine represented by chemical formulae (5) to (15) are used. Incidentally, the fluorination ratio of diamine is preferably higher. Also, as for the solvent in which the fluorinated PI precursor is dissolved, a known aprotic polar solvent such as N-methylpyrrolidone, N,N-dimethylacetamide, acetamide and N,N-dimethylformamide can be used. In this connection, the concentration, viscosity and the like of the fluorinated PI precursor solution can be appropriately selected and, if desired, other materials, additives and the like, such as an electrically conductive particle, may be added to the fluorinated PI precursor solution.

As regards the method for coating the fluorinated PI precursor solution on the PI film (base material layer 222) surface, there may be used a known method such as a flow coating method of ejecting the fluorinated PI precursor solution on the surface of the support 250 that is placed by arranging its axial direction substantially in parallel to the horizontal direction and is rotating in the circumferential direction, from a nozzle or the like provided nearly right above the support 250 while parallelly moving the support 250 or the nozzle in the axial direction, and a blade coating method where in the flow coating method above, the coating film formed on the support 250 surface is metered with a blade.

### (Fluorinated PI Precursor Drying Step)

In the fluorinated PI precursor drying step, as mentioned above, the solvent contained in the coating film formed on the PI film surface is preferably removed by heating/drying. The heating temperature is preferably not more than the boiling point of the solvent used and, for example, the heating temperature is preferably from 70 to 201° C. when the solvent is N-methylpyrrolidone (NMP, boiling point 202° C.) and preferably from 60 to 164° C. when the solvent is dimethylacetamide (DMAC, boiling point: 165° C.). More preferably, the solvent is removed by two-stage heating where the coating film is once heated at 60 to 125° C. that is not more than 125° C. at which imidation starts, thereby removing water being dissolved in the solvent and having an adverse effect on the fluorination, and then heated at a temperature not more than the boiling point of the solvent. The temperature in the second stage is, for example, preferably from 125 to 201° C. when the solvent is N-methylpyrrolidone (NMP, boiling point 202° C.) and preferably from 125 to 164° C. when the solvent is dimethylacetamide (DMAC, boiling point: 165° C.). The heating time varies depending on the concentration and thickness of the coating film coated, but the heating time in each stage is preferably on the order of 10 to 120 minutes. In the case where the coating film formed on the support 250 surface sags during drying by the effect of specific gravity, it is also preferred to heat and dry the coating film while rotating the support 250 at approximately from 10 to 60 rpm by keeping the axial direction on the horizontal.

### (Fluorinated PI Resin Film (Surface Layer) Forming Step)

Formation of the fluorinated PI film (surface layer 221) by heating the coating film dried through the fluorinated PI precursor drying step is preferably performed in a temperature range of from the boiling point of the solvent to about 400° C. for approximately from 20 to 120 minutes. At this time, the temperature is preferably raised stepwise or slowly at a constant rate until it reaches the above-described temperature. More preferably, heating/film formation is performed at temperatures in two stages or three stages. Incidentally, as the final temperature is higher, a stronger film is formed, and therefore, it is preferred to heat the coating film at 340° C. or more. Next, the PI resin film (base material layer 222) and fluorinated PI film (surface layer 221) formed on the support 250 surface through the heating step above are separated from the support 250 to obtain an endless belt 220. The thus-obtained endless belt 220 may be further subjected, if desired, to edge slitting, perforation punching, tape winding and the like.

### <Case Where Endless Belt is Formed From Plural Layers Consisting of Surface Layer, Base Material Layer and Elastic Layer>

This is fundamentally the same as the <Case Where Endless Belt is Formed From Plural Layers Consisting of Surface Layer and Base Material Layer> except that the later-described “Elastic Layer 233 Forming Step” is added. That is, the following “Elastic Layer Forming Step” is performed between the “PI Resin Film (Base Material Layer) Forming Step” and the “Fluorinated PI Precursor Coating Film Forming Step” in the <Case Where Endless Belt is Formed From Plural Layers Consisting of Surface Layer and Base Material Layer>.

### (Elastic Layer Forming Step)

An adhesive layer to impart adhesive property is coated on the PI resin film (base material layer) surface and then, a fluororubber solution is coated thereon, then air-dried and further vulcanized at 230° C. for 4 hours to stack a fluororubber layer in a total thickness of 180 μm.

### [Image Forming Apparatus]

An image forming apparatus using the endless belt of this exemplary embodiment is described below. The image forming apparatus of this exemplary embodiment may be any image forming apparatus as long as it is a known image forming apparatus capable of utilizing the endless belt of this exemplary embodiment. Specifically, for example, an image fixing apparatus having the following configuration is described below. That is, the image forming apparatus (image fixing apparatus) of this exemplary embodiment includes at least one or more driving members, an endless belt that is drivable and rotatable by the one or more driving members, and a pressing member, and in this image fixing apparatus, the surface of any one driving member out of one or more driving members and the outer circumferential surface of the endless belt are disposed to contact at the inner circumferential surface of the endless belt, a press-contact part (nip part) is formed by a pressing member that presses the outer circumferential surface of the endless belt toward the driving member surface, a recording sheet having on its surface an unfixed toner is passed through the nip part under heating, and the unfixed toner image is thereby fixed on the recording sheet surface, wherein the endless belt of this exemplary embodiment is used as the endless belt.

The image fixing apparatus of this exemplary embodiment uses the endless belt of this exemplary embodiment, so that the load torque of the driving member may be kept low and this may bring about not only enhanced durability to high-speed rotation but also reduced noise. Incidentally, the image fixing apparatus of the present invention may have other configurations and functions, if desired, in addition to the above-described configurations and functions. For example, a lubricant may be coated on the inner circumferential surface of the endless belt. As for the lubricant, a known liquid lubricant (e.g., silicone oil) can be used. Also, the lubricant can be continuously supplied through a felt or the like provided in contact with the inner circumferential surface of the endless belt.

In the image fixing apparatus of this exemplary embodiment, it is preferred that a pressure distribution of the nip part in the axial direction of the endless belt can be adjusted by the pressing member. For example, in the case of using a lubricant, by adjusting the pressure distribution, the manner in which the lubricant coated on the inner circumferential part is present may be arbitrarily controlled, for example, the lubricant may be gathered to one edge or center part of the endless belt. Therefore, for example, excess lubricant may be recovered by gathering it to one edge of the endless belt, or the lubricant may be moved to the center part of the endless belt and in turn, the inside of the apparatus may be prevented from contamination due to leakage of the lubricant from the edge part of the endless belt.

The adjustment of the pressure distribution is useful particularly when a lubricant is used and at the same time, roughness by streaky unevenness is imparted to the inner circumferential surface of the endless belt. In this case, when the pressure distribution of the nip part is adjusted by taking into consideration the streak direction in the roughness by streaky unevenness, this more facilitates the control of the manner in which the lubricant coated on the inner circumferential surface is present.

### EXAMPLES

### First Preferable Aspect

The roll for an image forming apparatus, which is a first preferable aspect of the present invention, and the production method thereof are described in greater detail below by referring to Examples. The present invention is not limited to the following Examples by any means.

Here, Examples 1 to 5 illustrate a roll for an image forming apparatus, where a single layer of a surface layer is formed on a support; Examples 6 to 10 illustrate a roll for an image forming apparatus, where a multilayer consisting of an elastic layer and a surface layer is formed on a support; and Comparative Examples 1 and 2 illustrate a case where a resin having no ether group in the main chain is used as the fluorinated polyimide resin.

### Example 1

Coating of a fluorinated PI precursor-containing solution on the support 50 surface is performed as follows by using a flow coating apparatus. As for the fluorinated PI precursor solution, an N-methylpyrrolidone solution of completely fluorinated polyamic acid composed of acid anhydride (10FEDA: 1,4-bis(3,4-dicarboxytrifluorophenoxy)tetrafluorobenzene and aromatic diamine (4FMPD: tetrafluoro-1,3-phenylenediamine) is used. Also, as for the support 50, an iron-made cylinder having an outer diameter of 30 mm, a length of 500 mm and a thickness of 0.5 mm is prepared. Subsequently, the N-methylpyrrolidone solution of completely fluorinated polyamic acid is coated on the support 50 surface by using the flow coating apparatus and then film-formed under heating in a nitrogen-purged heating furnace (inert oven). The heating is performed by the method of heating the coating film at 120° C. for 30 minutes, at 200° C. for 30 minutes, at 250° C. for 30 minutes, at 300° C. for 30 minutes and finally at 380° C. for 30 minutes to form a 1 μm-thick fluorinated PI resin film (surface layer 11) on the support 50 surface, whereby a roll 10 for an image forming apparatus, coated with a defect-free completely fluorinated PI resin film (surface layer 11) is obtained.

### Example 2

A roll 10 for an image forming apparatus, coated with a defect-free completely fluorinated PI resin film (surface layer 11) is obtained thoroughly in the same manner as in Example 1 except that the fluorinated PI precursor is composed of acid anhydride (10FEDA: 1,4-bis(3,4-dicarboxytrifluorophenoxy) tetrafluorobenzene dianhydride) and aromatic diamine (8FODA: 2,2′,3,3′,5,5′,6,6′-octafluoro-4,4′-diaminodiphenylether).

### Example 3

A roll 10 for an image forming apparatus, coated with a defect-free completely fluorinated PI resin film (surface layer 11) is obtained thoroughly in the same manner as in Example 1 except that the fluorinated PI precursor is composed of acid anhydride (10FEDA: 1,4-bis(3,4-dicarboxytrifluorophenoxy)tetrafluorobenzene dianhydride) and aromatic diamine (6FMDA: 4,4′-(hexafluoroisopropylidene)dianiline).

### Example 4

A roll 10 for an image forming apparatus, coated with a defect-free completely fluorinated PI resin film (surface layer 11) is obtained thoroughly in the same manner as in Example 1 except that the fluorinated PI precursor is composed of acid anhydride (10FEDA: 1,4-bis(3,4-dicarboxytrifluorophenoxy)tetrafluorobenzene and aromatic diamine (13FPD: 1,4-diamino-2-tridecafluoro-n-hexylbenzene).

### Example 5

A roll 10 for an image forming apparatus, coated with a defect-free completely fluorinated PI resin film (surface layer 11) is obtained thoroughly in the same manner as in Example 1 except that the fluorinated PI precursor is composed of acid anhydride (P6FDA: 3,6-bis(trifluoromethyl)-1,2,4,5-benzenetetracarboxylic dianhydride) and aromatic diamine (8FODA: 2,2′,3,3′,5,5′,6,6′-octafluoro-4,4′-diaminodiphenylether).

### Example 6

Using an iron-made cylinder having an outer diameter 30 mm and a length of 500 mm (thickness: 0.5 mm) as the support 50, a primer is coated as an adhesive layer on the support surface, and silicone rubber (produced by Shin-Etsu Chemical Co., Ltd.) is formed thereon to a thickness of 1 mm to provide a roll with an elastic layer. Subsequently, excimer vacuum ultraviolet light is irradiated on the surface of the elastic layer (silicone elastic layer) 22 by using a dielectric barrier discharge excimer lamp at a wavelength 172 nm (light intensity: 50 mW) while rotating the laminate of support 50 and elastic body 22 at a speed of 10 rpm. Incidentally, the distance between the irradiation surface of the excimer lamp and the silicone elastic layer is fixed to 5 mm, and light is irradiated for 3 minutes while purging with nitrogen. Thereafter, a fluorinated PI precursor solution (the N-methylpyrrolidone solution of completely fluorinated polyamic acid used in Example 1) is coated on the surface of the elastic layer 21 by using a flow coating apparatus and then film-formed under heating in a nitrogen-purged heating furnace (inert oven). The heating is performed by heating the coating film at 120° C. for 30 minutes, at 200° C. for 30 minutes, at 250° C. for 30 minutes and at 280° C. for 120 minutes to form a 1 μm-thick fluorinated PI resin film (surface layer 21) on the elastic body 22 surface, whereby a roll 20 for an image forming apparatus, coated with a defect-free completely fluorinated PI resin film (surface layer 21) is obtained.

### Example 7

A roll 20 for an image forming apparatus, coated with a 1 μm-thick defect-free completely fluorinated PI resin film (surface layer 21) is obtained thoroughly in the same manner as in Example 6 except that the fluorinated PI precursor is composed of acid anhydride (10FEDA: 1,4-bis(3,4-dicarboxytrifluorophenoxy)tetrafluorobenzene dianhydride) and aromatic diamine (8FODA: 2,2′,3,3′,5,5′,6,6′-octafluoro-4,4′-diaminodiphenylether).

### Example 8

A roll 20 for an image forming apparatus, coated with a 1 μm-thick defect-free completely fluorinated PI resin film (surface layer 21) is obtained thoroughly in the same manner as in Example 6 except that the fluorinated PI precursor is composed of acid anhydride (10FEDA: 1,4-bis(3,4-dicarboxytrifluorophenoxy)tetrafluorobenzene dianhydride) and aromatic diamine (6FMDA: 4,4′-(hexafluoroisopropylidene)dianiline).

### Example 9

A roll 20 for an image forming apparatus, coated with a 1 μm-thick defect-free completely fluorinated PI resin film (surface layer 21) is obtained thoroughly in the same manner as in Example 6 except that the fluorinated PI precursor is composed of acid anhydride (10FEDA: 1,4-bis(3,4-dicarboxytrifluorophenoxy)tetrafluorobenzene dianhydride) and aromatic diamine (13FPD: 1,4-diamino-2-tridecafluoro-n-hexylbenzene).

### Example 10

A roll 20 for an image forming apparatus, coated with a 1 μm-thick defect-free completely fluorinated PI resin film (surface layer 21) is obtained thoroughly in the same manner as in Example 6 except that the fluorinated PI precursor is composed of acid anhydride (P6FDA: 3,6-bis(trifluoromethyl)-1,2,4,5-benzenetetracarboxylic dianhydride) and aromatic diamine (8FODA: 2,2′,3,3′,5,5′,6,6′-octafluoro-4,4′-diaminodiphenylether).

### Comparative Example 1

A roll 20 for an image forming apparatus, coated with a 1 μm-thick defect-free partially fluorinated PI resin film (surface layer 21) is obtained thoroughly in the same manner as in Example 6 except that the fluorinated PI precursor is composed of acid anhydride (6FDA: 2,2-bis(3,4-anhydrodicarboxyphenyl)-hexafluoropropane) represented by the following chemical formula (16):

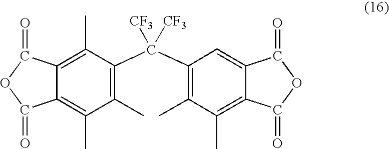

and aromatic diamine (TFDB: 2,2′-bis(trifluoromethyl)benzidine) represented by chemical formula (7). However, this partial fluorinated polyimide film is rigid because of having no ether bond and lacked flexibility.

### Comparative Example 2

A roll 20 for an image forming apparatus, coated with a 1 μm-thick defect-free partially fluorinated PI resin film (surface layer 21) is obtained thoroughly in the same manner as in Example 6 except that the fluorinated PI precursor is composed of acid anhydride (NTCDA: naphthalene-1,4,5,8-tetracarboxylic dianhydride) represented by the following chemical formula (17):

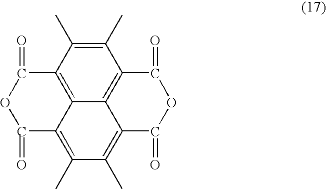

and aromatic diamine (TFDB: 2,2′-bis(trifluoromethyl)benzidine) represented by chemical formula (7). However, this partial fluorinated polyimide film is rigid because of having no ether bond and lacked flexibility.

### (Evaluation Test)

Each of the rolls for an image forming apparatus obtained in Examples 1 to 10 and Comparative Examples 1 and 2 using respective fluorinated polyimide resins is incorporated as a fixing roll into the fixing apparatus of a color multifunction machine (DocuCentre C7600, trade name, manufactured by Fuji Xerox Co., Ltd.), and a durability test and an image quality evaluation are performed by continuously feeding 200,000 sheets. In the fixing apparatus where the semiconductive roll of Examples 1 to 10 is incorporated, good durability and high image quality are obtained even after continuous feeding of 200,000 sheets, but in the fixing apparatus where the semiconductive roll of Comparative Examples 1 and 2 is incorporated, although good durability is obtained even after continuous feeding of 200,000 sheets, toner adhering to the roll due to bad releasability of the toner attached to the surface of the recording medium and contamination of the image is generated on the 10th sheet from the initiation, failing in obtaining good image quality over a long period of time.

### Second Preferable Aspect

The endless belt for an image forming apparatus, which is a second preferable aspect of the present invention, and the production method thereof are described in greater detail below by referring to Examples. The present invention is not limited to the following Examples by any means.

Here, Examples 2-1 to 2-7 illustrate an endless belt formed from a single layer; Examples 2-8 to 2-10 illustrate an endless belt formed from two layers; Examples 2-11 to 2-13 illustrate an endless belt formed from two layers and controlled in the electrical conductivity; and Comparative Examples 2-1 and 2-2 illustrate a case where a resin having no ether group in the main chain is used as the fluorinated polyimide resin.

### Example 2-1

Coating of a fluorinated PI precursor-containing solution on the support 250 surface is performed as follows by using a flow coating apparatus. As for the fluorinated PI precursor solution, an N-methylpyrrolidone solution of completely fluorinated polyamic acid composed of acid anhydride (10FEDA: 1,4-bis(3,4-dicaboxytrifluorophenoxy)tetrafluorobenzene dianhydride) represented by chemical formula (2) and aromatic diamine (4FMPD: tetrafluoro-1,3-phenylenediamine) represented by chemical formula (10) is used. As for the support 250, a support 250 whose surface had a surface roughness Ra of 2.0 μm in the axial direction and 0.3 μm in the circumferential direction is prepared by using an aluminum-made cylinder having an outer diameter of 30 mm and a length of 500 mm and subjecting its surface to cutting work in the circumferential direction. Furthermore, the support 250 surface is coated with a silicone-based releasing agent (KS700, trade name, produced by Shin-Etsu Chemical Co., Ltd.) and baked at 300° C. for 1 hour. Subsequently, the N-methylpyrrolidone solution of completely fluorinated polyamic acid is coated on the support 250 surface by using the flow coating apparatus and then film-formed under heating in a nitrogen-purged heating furnace (inert oven). The heating is performed by the method of heating the coating film at 120° C. for 30 minutes, at 200° C. for 30 minutes, at 250° C. for 30 minutes, at 300° C. for 30 minutes and finally at 380° C. for 30 minutes to form a fluorinated PI resin film on the support 250 surface. After cooling to room temperature, the fluorinated PI resin film is separated to obtain an endless belt formed from a defect-free completely fluorinated polyimide single layer, in which the belt film thickness is uniform and 50 μm. Also, since a releasing agent is previously coated on the support 250 surface, the inner circumferential surface of the endless belt is kept from adhering to the support 250 at the separation.

### Example 2-2

An endless belt formed from a defect-free completely fluorinated polyimide single layer is obtained thoroughly in the same manner as in Example 2-1 except that the fluorinated PI precursor is composed of acid anhydride (10FEDA: 1,4-bis(3,4-dicarboxytrifluorophenoxy)tetrafluorobenzene dianhydride) represented by chemical formula (2) and aromatic diamine (8FODA: 2,2′,3,3′,5,5′,6,6′-octafluoro-4,4′-diaminodiphenylether) represented by chemical formula (5).

### Example 2-3

An endless belt formed from a defect-free partially fluorinated polyimide single layer is obtained thoroughly in the same manner as in Example 2-1 except that the fluorinated PI precursor is composed of acid anhydride (10FEDA: 1,4-bis(3,4-dicarboxytrifluorophenoxy)tetrafluorobenzene dianhydride) represented by chemical formula (2) and aromatic diamine (6FMDA: 4,4′-(hexafluoroisopropylidene)dianiline) represented by chemical formula (6).

### Example 2-4

An endless belt formed from a defect-free partially fluorinated polyimide single layer is obtained thoroughly in the same manner as in Example 2-1 except that the fluorinated PI precursor is composed of acid anhydride (10FEDA: 1,4-bis(3,4-dicarboxytrifluorophenoxy)tetrafluorobenzene dianhydride) represented by chemical formula (2) and aromatic diamine (13FPD: 1,4-diamino-2-tridecafluoro-n-hexylbenzene) represented by chemical formula (9).

### Example 2-5

An endless belt formed from a defect-free completely fluorinated polyimide single layer is obtained thoroughly in the same manner as in Example 2-1 except that the fluorinated PI precursor is composed of acid anhydride (P6FDA: 3,6-bis(trifluoromethyl)-1,2,4,5-benzenetetracarboxylic dianhydride) represented by chemical formula (1) and aromatic diamine (8FODA: 2,2′,3,3′,5,5′,6,6′-octafluoro-4,4′-diaminodiphenylether) represented by chemical formula (5).

### Example 2-6

An endless belt formed from a defect-free partially fluorinated polyimide single layer is obtained thoroughly in the same manner as in Example 2-1 except that the fluorinated PI precursor is composed of acid anhydride (10FEDA: 1,4-bis(3,4-dicarboxytrifluorophenoxy)tetrafluorobenzene dianhydride) represented by chemical formula (2) and aromatic diamine (6FBAPP: 2,2-bis(p-(p-aminophenoxy)phenyl-1,1,1,3,3,3-hexafluoropropan e) represented by chemical formula (15).

### Example 2-7

An endless belt formed from a defect-free partially fluorinated polyimide single layer is obtained thoroughly in the same manner as in Example 2-1 except that the fluorinated PI precursor is composed of acid anhydride (6FDA: 2,2-bis(3,4-anhydrodicarboxyphenyl)-hexafluoropropane) represented by chemical formula (3) and aromatic diamine (6FBAPP: 2,2-bis (p-(p-aminophenoxy)phenyl-1,1,1,3,3,3-hexafluoropropan e) represented by chemical formula (15).

### Example 2-8

An endless belt formed from two layers is obtained as follows by coating a PI precursor-containing solution on the support 250 surface by means of a flow coating apparatus, then film-forming the coating under heating to form a normal PI endless belt, and further coating fluorinated polyimide on the surface by means of the flow coating apparatus. As for the PI precursor solution, an N-methylpyrrolidone solution of PI precursor (U-Varnish, trade name, produced by Ube Industries, Ltd., solid content concentration: 18%, viscosity: about 5 Pas) is used. As for the support 250, a support 250 whose surface had a surface roughness Ra of 2.0 μm in the axial direction and 0.3 μm in the circumferential direction is prepared by using an aluminum-made cylinder having an outer diameter of 30 mm and a length of 500 mm and subjecting its surface to cutting work in the circumferential direction. Furthermore, the support 250 surface is coated with a silicone-based releasing agent (KS700, trade name, produced by Shin-Etsu Chemical Co., Ltd.) and baked at 300° C. for 1 hour. Subsequently, the N-methylpyrrolidone solution of PI precursor is coated on the support 250 surface by using the flow coating apparatus and then film-formed under heating in a nitrogen-purged heating furnace (inert oven). The heating is performed by the method of heating the coating film at 120° C. for 30 minutes, at 200° C. for 30 minutes, at 250° C. for 30 minutes, at 300° C. for 30 minutes and finally at 380° C. for 30 minutes to form a fluorinated PI resin film on the support 250 surface. After cooling to room temperature, the PI resin film is separated to obtain an endless belt formed from a defect-free polyimide single layer, in which the belt film thickness is uniform and 50 μm Thereafter, a fluorinated polyimide film is formed on the surface of the polyimide single layer by using the same flow coating apparatus. As for the fluorinated PI precursor solution, an N-methylpyrrolidone solution of completely fluorinated polyamic acid for optical waveguide, composed of acid anhydride (10FEDA: 1,4-bis(3,4-dicaboxytrifluorophenoxy)tetrafluorobenzene dianhydride) represented by chemical formula (2) and aromatic diamine (4FMPD: tetrafluoro-1,3-phenylenediamine) represented by chemical formula (10), is used. The coating film is then film-formed under heating in a nitrogen-purged heating furnace (inert oven). The heating is performed by the method of heating the coating film at 120° C. for 30 minutes, at 200° C. for 30 minutes, at 250° C. for 30 minutes, at 300° C. for 30 minutes and finally at 380° C. for 30 minutes to form a fluorinated PT resin film on the support 250 surface. After cooling to room temperature, the resin formed from two layers of PI resin film and fluorinated PI resin film is separated from the support 250 to obtain an endless belt formed from two layers and coated with a defect-free completely fluorinated polyimide, in which the film thickness of the belt layer is 70 μm. Respective PI layers are adhered firmly and kept from separation and since a releasing agent is previously coated on the support 250 surface, separation of the endless belt from the support 250 is easy.

### Example 2-9

An endless belt formed from two layers and coated with a defect-free partially fluorinated polyimide is obtained thoroughly in the same manner as in Example 2-8 except that an N-methylpyrrolidone solution of fluorinated polyamic acid composed of acid anhydride (10FEDA: 1,4-bis(3,4-dicarboxytrifluorophenoxy)tetrafluorobenzene dianhydride) represented by chemical formula (2) and aromatic diamine (6FBAPP: 2,2-bis(p-(p-aminophenoxy)phenyl-1,1,1,3,3,3-hexafluoropropan e) represented by chemical formula (15) is used as the fluorinated PI precursor solution.

### Example 2-10

An endless belt formed from two layers and coated with a defect-free partially fluorinated polyimide is obtained thoroughly in the same manner as in Example 2-8 except that an N-methylpyrrolidone solution of fluorinated polyamic acid composed of acid anhydride (6FDA: 2,2-bis(3,4-anhydrodicarboxyphenyl)-hexafluoropropane) represented by chemical formula (3) and aromatic diamine (6FBAPP: 2,2-bis (p-(p-aminophenoxy)phenyl-1,1,1,3,3,3-hexafluoropropan e) represented by chemical formula (15) is used as the fluorinated PI precursor solution.

### Example 2-11

An endless belt formed from two layers, in which the inner surface is semiconductive and the outer surface is water-repellent, is obtained in the same manner as in Example 2-6 except for using, in place of the PI precursor solution used in Example 2-6, a solution prepared by previously dispersing therein carbon black (Ketjen Black EC600JD, produced by Ketjen Black International) in a concentration of 10 mass %.

### Example 2-12

An endless belt formed from two layers, in which the inner surface is insulating and the outer surface is semiconductive, is obtained in the same manner as in Example 2-6 except for using, in place of the fluorinated PI precursor solution used in Example 2-6, a solution prepared by previously dispersing therein carbon black (Ketjen Black EC600JD, produced by Ketjen Black International) in a concentration of 10 mass %.

### Example 2-13

An endless belt formed from two layers, in which the inner surface is insulating and the outer surface had both semiconductivity and water repellency, is obtained in the same manner as in Example 2-6 except for using, in place of the fluorinated PI precursor solution used in Example 2-6, a mixed solution of a solution prepared by previously dispersing therein carbon black (Ketjen Black EC600JD, produced by Ketjen Black International) in a concentration of 10 mass % and a fluororesin dispersion solution obtained by dispersing the carbon in N-methylpyrrolidone (KD1000AS, fluororesin solid content concentration: 40 mass %, produced by Kitamura Limited).

### Comparative Example 2-1

A semiconductive endless belt formed from a defect-less semiconductive fluorinated polyimide single layer is obtained in the same manner as in Example 2-1 except for using a solution obtained by dispersing 3 mass % of carbon black (Ketjen Black EC600JD, produced by Ketjen Black International) in an N-methylpyrrolidone solution (solid content concentration: 18 mass %) of partially fluorinated polyamic acid in which the semiconductive fluorinated PI precursor is composed of acid anhydride (6FDA: 2,2-bis(3,4-anhydrodicarboxyphenyl)-hexafluoropropane) represented by chemical formula (3) and aromatic diamine (TFDB: 2,2′-bis(trifluoromethyl)benzidine) represented by chemical formula (7). However, this partially fluorinated polyimide film is rigid because of having no ether bond and lacked flexibility.

### Comparative Example 2-2

A semiconductive endless belt formed from a defect-less semiconductive fluorinated polyimide single layer is obtained thoroughly in the same manner as in Example 2-1 except for using a solution obtained by dispersing 3 mass % of carbon black (Ketjen Black EC600JD, produced by Ketjen Black International) in an N-methylpyrrolidone solution (solid content concentration: 18 mass %) of partially fluorinated polyamic acid in which the semiconductive fluorinated PI precursor is composed of acid anhydride (NTCDA: naphthalene-1,4,5,8-tetracarboxylic dianhydride) represented by the following chemical formula (17):

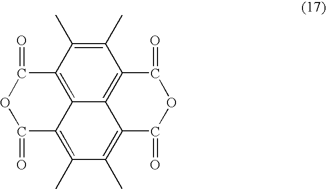

and aromatic diamine (TFBD: 2,2′-bis(trifluoromethyl)benzidine) represented by chemical formula (7). However, this partial fluorinated polyimide film is rigid because of having no ether bond and lacked flexibility.

### (Evaluation Test)

Each of the endless belts obtained in Examples 2-1 to 2-13 and Comparative Examples 2-1 and 2-2 using respective fluorinated polyimide resins is incorporated, as a pressure belt for fixing, into the fixing apparatus of a color multifunction machine (DocuCentre C7600, trade name, manufactured by Fuji Xerox Co., Ltd.), and a durability test and an image quality evaluation are performed by continuously feeding 200,000 sheets. In the fixing apparatus where the semiconductive endless belt of Examples 2-1 to 2-13 is incorporated, good durability and high image quality are obtained even after continuous feeding of 200,000 sheets. On the other hand, in the fixing apparatus where the semiconductive endless belt of Comparative Examples 2-1 and 2-2 is incorporated, although good durability is obtained even after continuous feeding of 200,000 sheets, toner adhering to the endless belt due to bad releasability of the toner attached to the surface of the recording medium and contamination of the image is generated on the 10th sheet from the initiation, failing in obtaining good image quality over a long period of time.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention defined by the following claims and their equivalents.

What is claimed is:

1. A member for an image forming apparatus, comprising:
a surface layer, at least an outer surface of the surface layer containing a fluorinated polyimide resin that has an ether group in a main chain of the fluorinated polyimide resin.

2. The member for an image forming apparatus according to claim 1,
wherein the fluorinated polyimide resin is a resin prepared from a fluorinated polyamic acid, and
the fluorinated polyamic acid is synthesized using an at least partially fluorinated acid anhydride and an at least partially fluorinated diamine.

3. The member for an image forming apparatus according to claim 2,
wherein the at least partially fluorinated acid anhydride and the at least partially fluorinated diamine have at least one of a fluorine group (—F) and a perfluoroalkyl group (—CₙF₂ₙ₊₁), where n is an integer of 1 or more.

4. The member for an image forming apparatus according to claim 3,
wherein the at least partially fluorinated acid anhydride is selected from the group consisting of compounds represented by following formulae (1) to (3), and
the at least partially fluorinated diamine is selected from the group consisting of diamines represented by following formula (4): 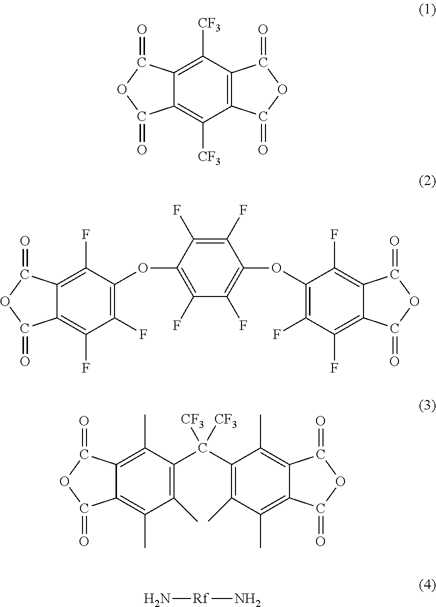
wherein Rf is a fluorinated aromatic compound.

5. The member for an image forming apparatus according to claim 4,
wherein the at least partially fluorinated diamine is selected from diamines represented by following formulae (5) to (15):

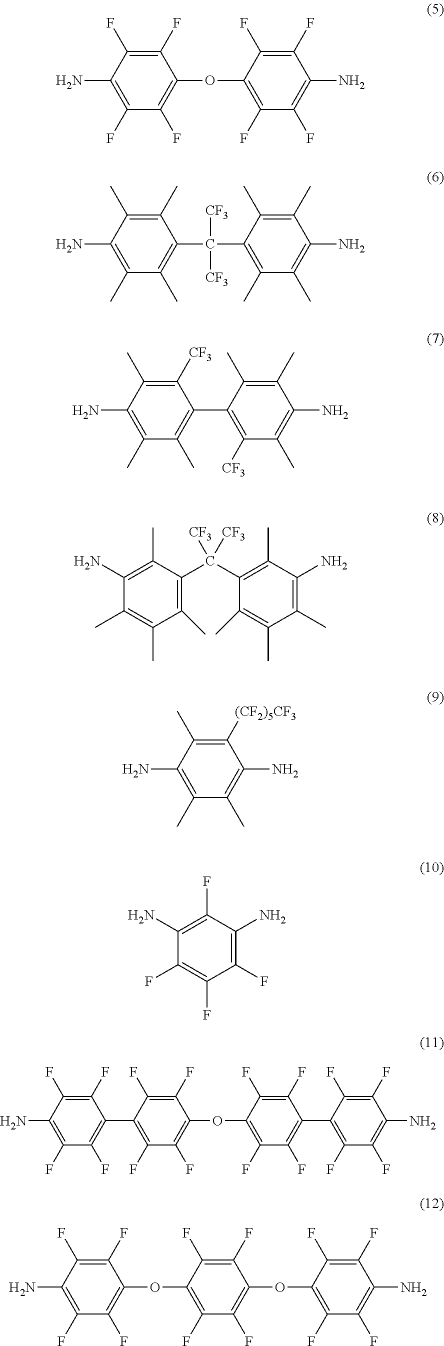

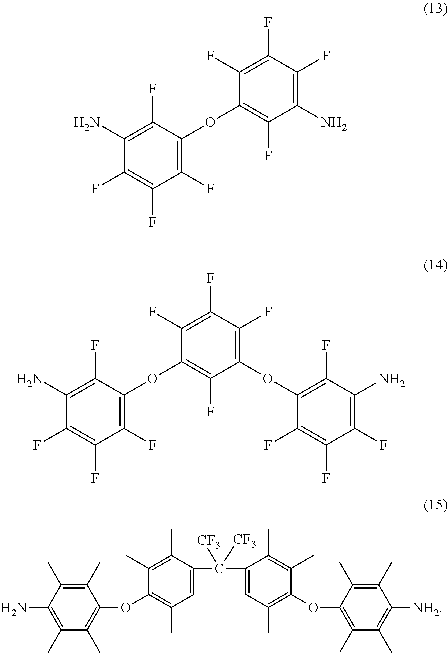

6. The member for an image forming apparatus according to claim 1,
wherein the surface layer is formed from a plurality of layers.

7. The member for an image forming apparatus according to claim 1,
wherein the surface layer is formed from a single layer, and
a content of the fluorinated polyimide resin is increased stepwise or gradiently from an inner side to an outer side of the surface layer.

8. The member for an image forming apparatus according to claim 1, further comprising:
a base layer stacked on or above a back surface side of the surface layer.

9. The member for an image forming apparatus according to claim 8,
wherein at least an inner surface of the base layer is composed of a polyimide or polyamide.

10. The member for an image forming apparatus according to claim 8, further comprising:
an elastic layer as an intermediate layer between the surface layer and the base layer.

11. The member for an image forming apparatus according to claim 1, which is in the form of an endless belt.

12. The member for an image forming apparatus according to claim 1, which is in the form of a roll.

13. The member for an image forming apparatus according to claim 1,
wherein a surface resistivity of the surface layer is about from 10⁴ to 10¹² Ω/square.

14. The member for an image forming apparatus according to claim 1,
wherein a surface resistivity of the surface layer is about from 10⁴ to 10⁶ Ω/square.

15. The member for an image forming apparatus according to claim 1,
wherein a surface resistivity of the surface layer is about from 10⁸ to 10¹² Ω/square.

16. The member for an image forming apparatus according to claim 11,
wherein, in the surface layer, a surface roughness Ra on an outer circumferential surface of an outermost layer is smaller than a surface roughness Ra on an inner circumferential surface of an innermost layer.

17. The member for an image forming apparatus according to claim 12,
wherein the surface layer has a film thickness of about 0.5 to 20 μm.

18. An image forming apparatus, using the member for an image forming apparatus according to claim 1.

19. A unit for an image forming apparatus, using the member for an image forming apparatus according to claim 1.
